(19) United States
(12) Patent Application Publication
(10) Pub. No.: US 2009/0303013 A1
(43) Pub. Date: Dec. 10, 2009

(54) SYSTEMS AND METHODS FOR WIRELESS CONTROL OF EQUIPMENT

(75) Inventor: John W. Edgerton, Akron, OH (US)

Correspondence Address: HAHN LOESER & PARKS, LLP, One GOJO Plaza, Suite 300, AKRON, OH, 44311-1076, US

(73) Assignee: The University of Akron, Akron, OH (US)

(21) Appl. No.: 12/479,381

(22) Filed: Jun. 5, 2009

Related U.S. Application Data
(60) Provisional application No. 61/058,950, filed on Jun. 5, 2008.

(51) Int. Cl. H04Q 5/22

(52) U.S. Cl. 340/10.1

(57) ABSTRACT

Systems and methods for wirelessly controlling equipment or apparatus by employing radio frequency identification (RFID) technology. The systems and methods provide the capability to manually or automatically select an RFID tag or change the encoded information in an RFID tag to wirelessly change the control state of a piece of equipment or an apparatus. The system includes an RFID based selector including at least one RFID tag, and an RFID reader capable of wirelessly reading RFID codes from the RFID tags of the RFID based selector. The system further includes a control mechanism capable of changing a control state of said equipment or apparatus in response to said read RFID codes. To expand the system capabilities yet keep power requirements at the selector to a minimum, methods are included of passive addressing of many pushbuttons in the selector. Wireless and battery free selectors are explained. Utilizing the inherent ID code of the tag permits management of which selectors are virtually connected.

### TECHNICAL FIELD

Examples of the present invention relate to the control of equipment and apparatus. More particularly, examples of the present invention relate to systems and methods for wirelessly controlling equipment and apparatus by employing radio frequency identification (RFID) technology.

### BACKGROUND

Many applications of radio frequency identification (RFID) focus on tracking items, for example, through manufacturing processes and through retail chains. Only in a few cases has RFID technology been used to transmit data about the tagged item to the reader. For example, such data as temperature and humidity have been exploited by the United States Department of Defense (USDOD) in RFID applications. The USDOD has tested a modification of RFID tags to sense pressure, temperature, and humidity on high value items. Data is acquired about the environment of the tagged item, but not for controlling a machine or equipment.

Radio frequency identification uses a transponder tag, also referred to as an RFID tag, consisting of an antenna and an integrated circuit chip. When the tag is in the presence of an electromagnetic field (i.e., a radio signal) of proper frequency and sufficient strength, the antenna may receive electrical energy to operate the chip. The energized chip may send out a backscatter radio signal containing digital information with which the chip has been previously programmed. The antenna of the tag may have, for example, dimensions of from a few millimeters to several centimeters, while the chip is usually less than a few millimeters, if it is present at all.

Another component of an RFID system is the reader which may include one or more antennas and a transceiver. The reader broadcasts the radio signal and subsequently listens for the backscatter signal from the tag or tags in the working range and detects the digital information. The reader interfaces to the remaining part of the system (e.g., a coded door lock, a computer database in a world-wide supply chain, or other applications).

Operating frequencies in the United States exist in several unlicensed radio frequency bands. For example, a low frequency (LF) band which is around 125 kHz is used for short range applications near fluids, a high frequency (HF) band which is around 13.56 MHz is used in manufacturing and parts tracking, and an ultra high frequency (UHF) band around 915 MHz is used for long-range applications. Microwave applications, for example 2.4 GHz are in use as well. It should be recognized that any desired frequency or frequency bands may be used in accordance with the invention. In other countries, similar but slightly different bands are in use. For reasons of international operation, efforts are underway to standardize frequencies between countries.

Examples of operational powers range from several milliwatts to a few watts, providing operating ranges of a centimeter or less out to about ten meters. An operating range of 50 feet for passive RFID tags has been reported.

Many RFID systems use passive tags that have no batteries, deriving operating power from the received radio signal and having unlimited useful life. Some systems use tags that include batteries to assist the operation of the chip and provide an extended range of operation. Such tags are referred to as being active, and have a useful life of, for example, two to three years. Some active tags periodically emit brief radio signals referred to as chirping. Other active tags, referred to as semi-active, only turn on when they detect a radio signal from a reader.

A primary use of RFID has been to track objects such as, for example, items in a retail chain or materials in a supply chain. RFID tracking has significant advantages over bar code tracking. A bar code is read with a manual optical reader and may contain only sufficient data to identify the manufacturer and item type. A common RFID tag may hold 96 binary bits of information amounting to more than 10²⁸ possible different codes. Such information capacity is more than sufficient to uniquely identify not only manufacturer and item type, but also uniquely identify each individual item, for example. Other RFID tags may hold more or less information.

Such an RFID system may replace a bar code manual reader with an automatic reading system that does not have the tight directional restrictions of the bar code reader. Furthermore, radio waves easily pass through many materials that are opaque to light. RFID readers are available which may read many tags nearly simultaneously in a bulk processing environment.

Other uses of RFID technology have become available as well. For example, proximity detection for key-less lock entry is one application, and tags on the shoes of marathon runners to time a race is another application. A recent application to medicine uses RFID to detect esophageal reflux, and combines RFID technology with sensor technology to measure and transmit data from within the body of a patient to a wireless receptor hanging around the neck of the patient.

Further uses of RFID technology are desirable, and examples according to aspects of the present invention will become apparent to one of skill in the art, as set forth in the remainder of the present application with reference to the drawings.

### BRIEF SUMMARY

Certain embodiments or examples of systems and methods according to the invention are described herein and provide for wireless remote control of equipment or devices using RFID technology. Such embodiments allow meaningful control information originating at an RFID tag to be transmitted to the controlled equipment or devices. The source of the meaningful control information may be a human operator, for example, operating a handheld or other control pad or system. In other embodiments or examples, the systems and methods may be generalized to include non-human sources of meaningful control, such as a part of a machine actuating a control signal, for example.

Certain embodiments of systems and methods herein may utilize battery power supplies or may not require batteries or any other power source at the RFID tag. RFID tags or devices according to examples of the invention may receive the electrical energy needed for their operation from an interrogating radio signal. However, battery operation is possible as well using active or semi-active RFID tags. Tags have been demonstrated that have no IC at all, but only the antenna generating backscatter. From the point of view of the present invention, these could be used as well in select embodiments that will be described. Embodiments of systems and methods herein provide a virtual connection (or disconnection) of a control tag to the controlled equipment. Further, the systems and methods may utilize the built-in identification component of the tag, to make each virtual connection unique.

Systems and methods according to examples of the invention may utilize modified RFID tags and readers, to wirelessly control electrical equipment or devices. Controlling codes may be generated at a tag by mechanically shielding or exposing one or more tags such that a reader may read only desired exposed tag identification(s) or ID(s). The reader may then interpret the control action from the specific ID(s) read. If the tags are active and battery powered, then the batteries may be selectively connected to the tags to be activated when desired. Again, the reader may interpret the requested control action from the specific ID(s) read.

Furthermore, in examples of the invention, tag ID bits may be used as code bits to encode the control request. Alternatively, in addition to the ID bits, additional bits may be implemented to be used as code bits. To permit management of these code bits at the tag, pins may be added to the tag integrated circuit (IC) to allow such code signals to be brought into the IC. A portion of the equipment or device to be controlled may include a modified reader. The reader may check a received ID for validity and then interpret the control request to the equipment or device being controlled.

These and other advantages and novel features of the present invention, as well as details of illustrated embodiments thereof, will be more fully understood from the following description and drawings.

### BRIEF DESCRIPTION OF THE DRAWINGS

FIG. 1 illustrates a functional block diagram of an exemplary embodiment showing both segments of the system, a wall mounted switch including two RFID tags with a switch lever mechanically connected to a shield that alternately exposes one or the other tag, and the RFID reader interfaced to the controlled load;

FIG. 2 illustrates a functional block diagram of an exemplary embodiment of a wireless switch using a plurality of RFID tags;

FIG. 3A shows an RFID tag having a portion of its antenna shielded, and FIG. 3B shows that same tag with antenna fully exposed;

FIG. 4 illustrates a functional block diagram of an exemplary embodiment of providing six pins on a chip in an RFID tag to allow five external switches to control a portion of the binary data transmitted by the tag;

FIG. 5A illustrates a functional block diagram of an exemplary embodiment of a two-dimensional matrix addressing scheme for a sixteen-key keypad using RFID technology, with FIG. 5B showing the details at one key;

FIG. 6 illustrates a functional block diagram of an exemplary embodiment of a three-dimensional matrix addressing scheme for a twenty-seven-key keypad using RFID technology;

FIG. 7 illustrates an exemplary embodiment of a switch employing two RFID tags that has been built and tested; and

FIG. 8A illustrates an exemplary embodiment, that has been built and tested, of a switch employing one RFID tag with a pair of small wires soldered to its antenna, and FIG. 8B illustrates that same tag with the wires shorting out the antenna, resulting in the tag not being read.

FIG. 9 is a schematic diagram of a passive switch addressing scheme using a 3-dimensional matrix pattern.

FIG. 10a is passive switch addressing scheme using all possible combinations, and shows a table representing the addressing scheme.

FIG. 10b is a circuit diagram of the example shown in FIG. 10a.

FIG. 11 is a flow chart of a method according to an example.

FIGS. 11a-11e are flow charts showing details of the method of FIG. 11.

FIG. 12 is a schematic diagram of an example according to the invention.

FIG. 13 is a schematic diagram of an example according to the invention.

FIG. 14 is a schematic diagram of an example according to the invention.

FIG. 15 is a schematic illustration of an example of a piezoelectric power source used in an example of the invention.

FIG. 16 is a schematic illustration of an example of a piezoelectric power source used in an example of the invention.

FIG. 17 is a schematic circuit diagram of an example of the invention.

FIG. 18 is illustration of a SAW RFID system.

FIG. 19 is a schematic circuit diagram of an example of the invention.

### DETAILED DESCRIPTION

Turning now to the Figures, various examples or embodiments of the present invention use RFID tags and associated systems as a mechanism to wirelessly generate and transmit control codes originated by a person, equipment or other suitable source, to a system that responds to that control request.

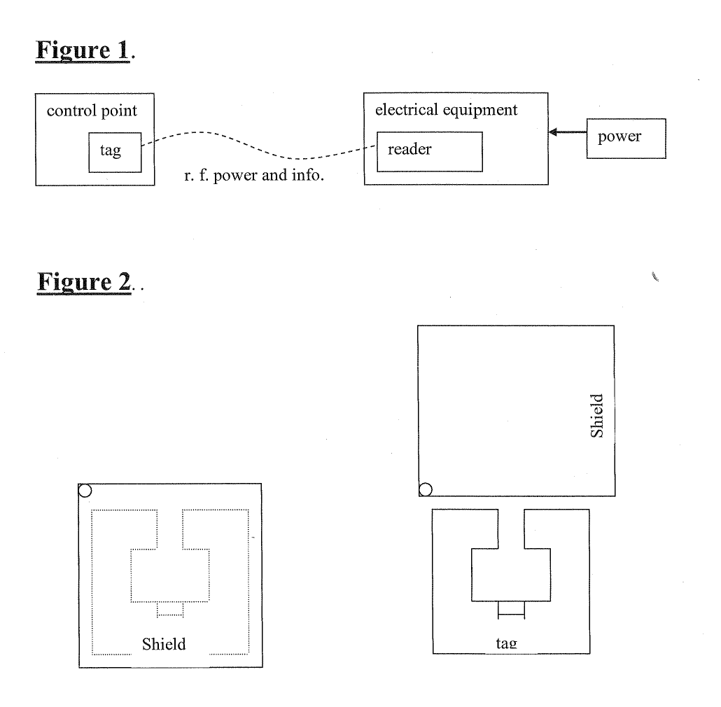

As an example, such a system could be a wall mounted switch that may include two RFID tags with the switch lever mechanically connected to a RF shield that alternately exposes one or the other tag (see FIG. 1). The controlled equipment, which includes an RFID transceiver, responds to the control code as requested by the exposed tag. Such an embodiment may be implemented using passive tags or active tags. In another example, an external mechanical input exposes or alternately shields one, or one of two tags.

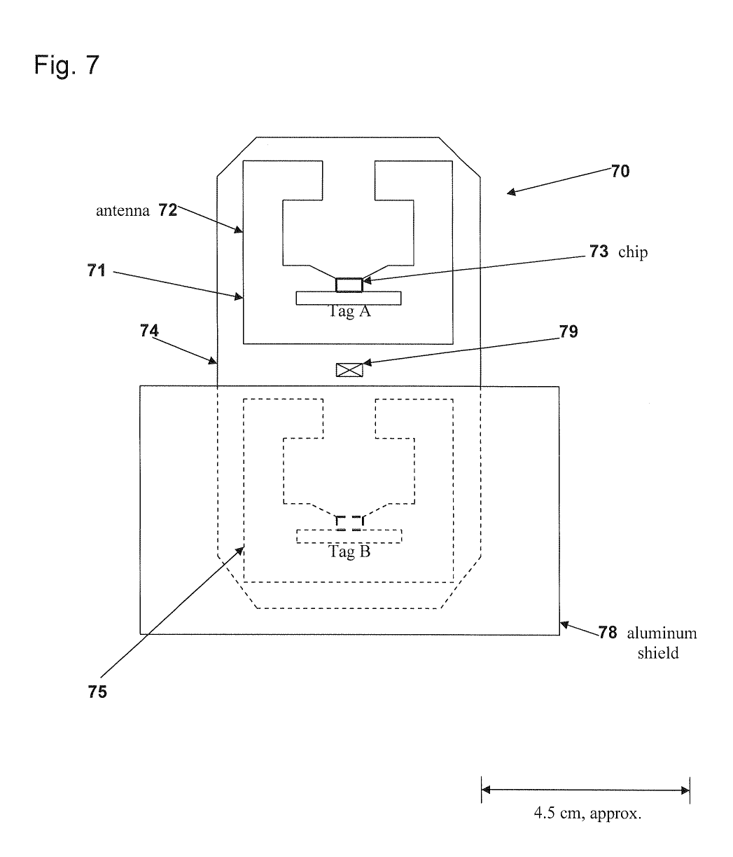

FIG. 1 illustrates an exemplary embodiment of using a switching device 10 in conjunction with controlled equipment 16. The switching device 10 may simply be a lever throw switch, but any suitable switching arrangement may be implemented. In this example, the switch lever 12 may be provided for actuation in association with any suitable support 14, and mechanically connected to a radio frequency shield 15. In this example, the switch arrangement 10 includes a pair of RFID tags 11 and 13, but it should be understood that only one, or any plurality of tags, may be used. The shield 15 may be made of any suitable material (e.g., aluminum) which shields one or more of the tags 11, 13, etc. enclosed in the switch 10, from an interrogating electromagnetic field. The controlled equipment 16 may include a RFID reader and interface 19, which may be embedded in the equipment 16. The equipment 16 may also have one or more electrical loads 18, and a power supply 90, which may be an external supply as shown, or an internal battery power supply or the like if desired. An example of the antenna portion 17 of the reader is shown for reference. When a tag 13 or 11 is shielded, the reader 19 does not register the tag. When a tag 11 or 13 is exposed, the reader 19 is able to register the tag (i.e., read the encoded information of the tag). Although use of one tag may be acceptable, the use of two tags may allow the system to operate such that “no read” may be interpreted by the controlled equipment as a fault, or ignored until a next read provides meaningful results. FIG. 7 is a sketch of a specific tested prototype switch, 70, utilizing two tags, A and B, 71 and 75 respectively, mounted on a backing, 74. A plastic shaft, 79 permits rotating the tag pair so alternately Tag B is shielded by the aluminum envelope, 78 (the situation illustrated) or Tag A is shielded by the aluminum envelope. The exposed tag (Tag A as shown) is the one available to be read. For reference, Tag A's integrated circuit chip, 73 and antenna, 72 are indicated. Such embodiments may be implemented using passive tags or active tags.

In accordance with another embodiment, a method to cause the one or more RFID tags to effectively transmit a control code is provided using active tags. A battery (or batteries) of an active tag is switched on or off, resulting in selection of the tag(s) whose identifications are desired to transmit one or more control codes. For example, consider a simple two-tag, on-off system similar to the previous example of FIG. 1. Instead of using a movable shield, one battery may be alternatively connected to each RFID tag, with it being selectively switched to power up one tag (e.g., the “on” tag), and when desired, switched to power up the other tag (e.g., the “off” tag). Alternatively, independent battery power supplies may be selectively used to power up the desired RFID tag.

In accordance with certain embodiments, an external mechanical input device or system can be used to selectively expose any pattern of a plurality of tags. Relating to this, FIG. 2 illustrates another exemplary embodiment of an implementation of an eight-position rotary switch 20 that may be used in such a manner. Various other input devices would be suitable and are contemplated by the invention. In this example, the rotary switch 20 may include a shield portion 24 formed over at least a portion of a mechanical support 22, that is mechanically rotatable in any suitable manner, such as by a controlling knob 26. The shield 24 and knob 26 for the rotary switch 20 may be both provided on the same axis 27 as shown in this example, or on different axes if desired. In the example shown, the axis 27 is perpendicular to the mechanical support 22. In this example, a plurality of RFID tags 25 is provided. The shield 24 is designed to have a portion 23 removed such that all tags 25 except one are shielded at any one time. Then, by rotating the controlling knob the user may select the tag to be read and thus the control function to be implemented. With only one tag, for example tag 21, exposed at a time, the complexity of nearly simultaneous multiple tag reads is eliminated. However, if a system's overall performance or function may be sufficiently enhanced to justify the complexity of multiple tag reads, then a different shield pattern may be implemented to allow more than one tag to be selectively exposed. For example, if overall reliability or function is enhanced by exposing tags that are perpendicular to each other, then the shield may be designed with two openings centered 90-degrees (or other angle) apart. In the eight-tag example, this would expose tags A and C, or B and D, or C and E, and so on. Such a design may also support a system in which the polarity angle of either a transmitted or a received electromagnetic field is distinguishable. It should also be understood that any other suitable shielding arrangement may be provided to allow for selective transmission or shielding of any tag in an arrangement of tags 25. It should be recognized that the example shown in FIG. 2 could be modified to have any number of tags 25, any shielding arrangement or other variations for an application.

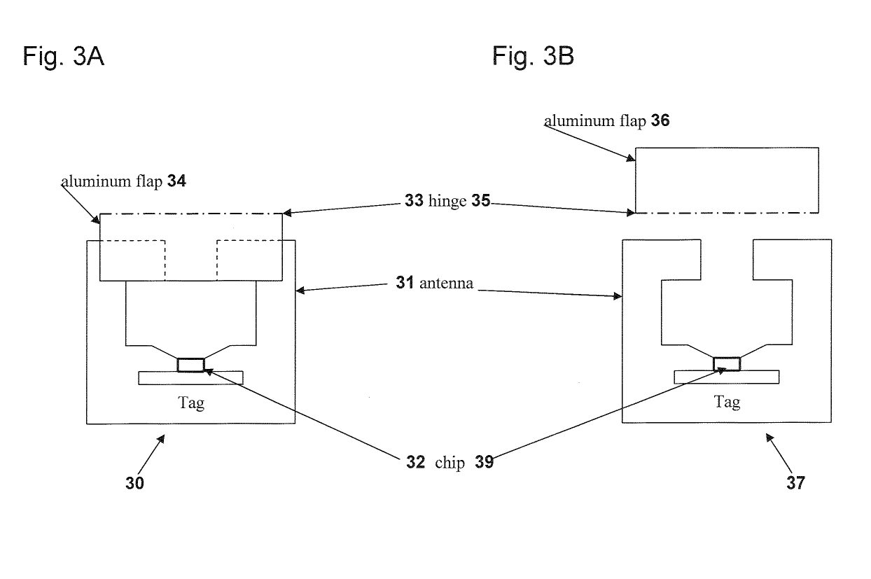

In alternative examples in accordance with certain embodiments, the tag mechanical support may be moved, leaving the shield in a fixed position. Both FIGS. 1 and 2 suggest a switch in which the tags are in fixed position and the shield's position is moved by the switch, lever, or knob. Alternately, the shield's position may be fixed and the mechanical switch, lever, or knob may be designed to move the tag(s). In examples of the invention, various methods for modifying a tag's response to the reader's interrogating signal are possible and contemplated. Such methods and arrangements may therefore provide the wireless, battery-less control of equipment or other components, using passive RFID tags. The shielding of one or more tags as described above in reference to FIGS. 1 and 2 provides one method of modifying the response of a tag to the interrogating signal from a reader, but other approaches are also possible. As another example, the shielding may effectively be performed by covering only a portion of the area of the antenna of an RFID tag. For example, as seen in FIG. 3A, a tag 30 may have a portion of an antenna 31 covered by a shielding member 34 of any desired configuration. For example, it has been found that shielding of only about one-fifth of the area of antenna 31 may be effective at preventing reading by a RFID reader, and/or bringing the shielding 34 into very close proximity to the portion of antenna 31 which may effectively cause a capacitive short between sections or portions of the antenna 31 if the shielding member 34 is formed of a conductive material. In such an arrangement, if the shield 34 is moved to a position slightly away from the antenna 31, the tag 30 can be read. For example, FIG. 3B is simply 3A with the shield 36 in a position to permit the tag 37 to be read. As further reference for example, both FIGS. 3A and 3B show a hinge 33 and 35 to facilitate movement of the shield 34 and 36. FIGS. 3A and 3B also show exemplary chip portion 32 and 39 of the tag. The shielding arrangements 34 and 36 may thus be configured in any suitable manner and moved in any suitable manner to effectively make a tag unreadable when desired.

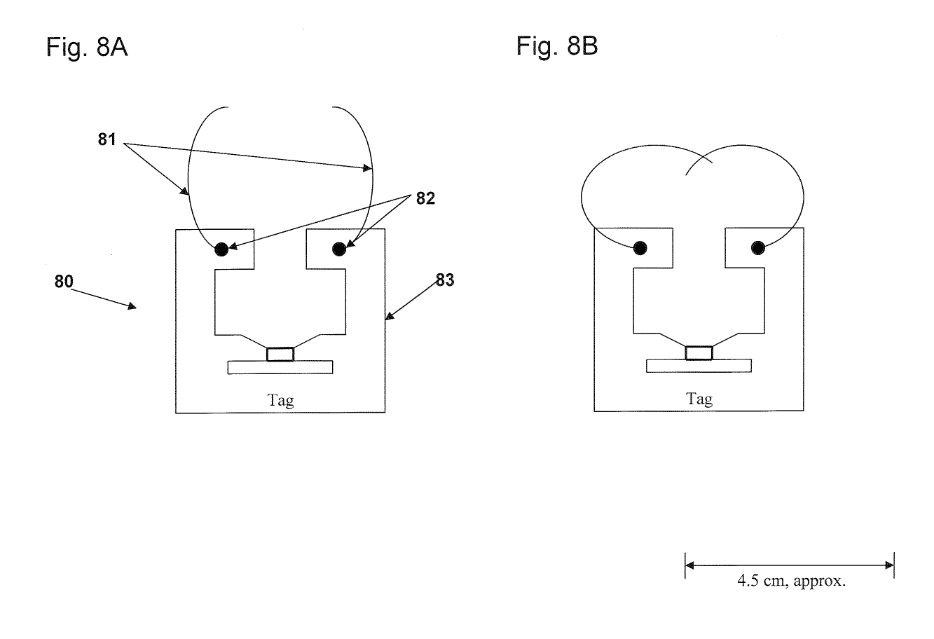

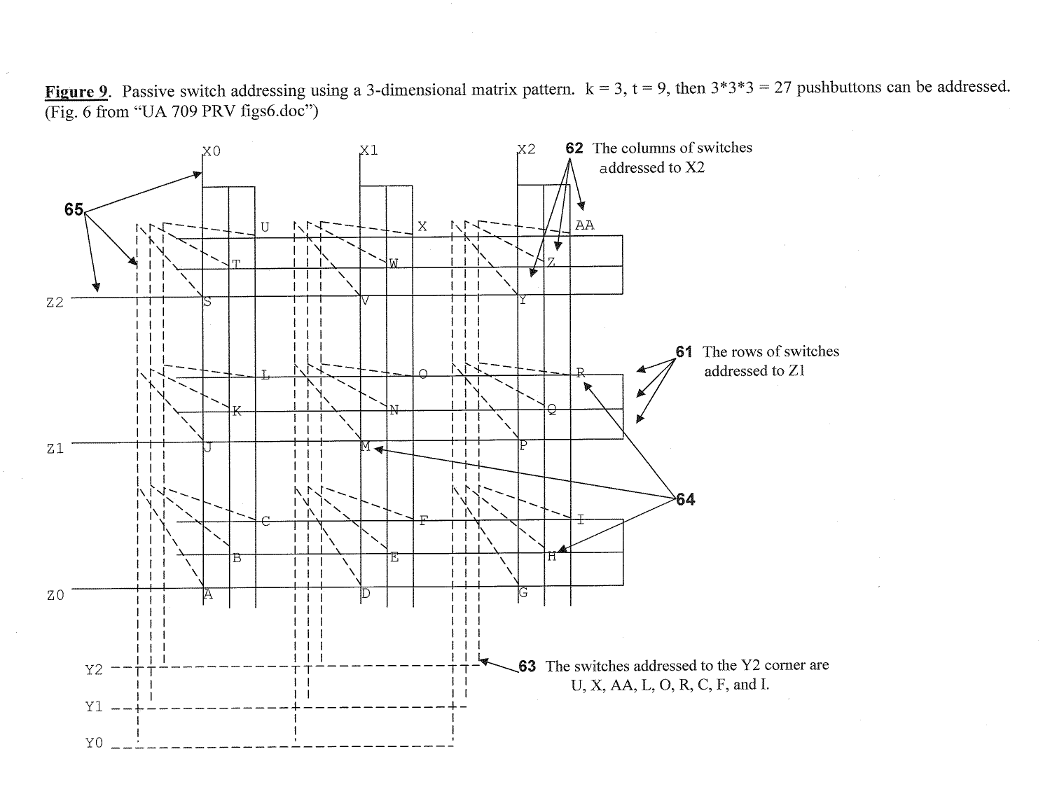

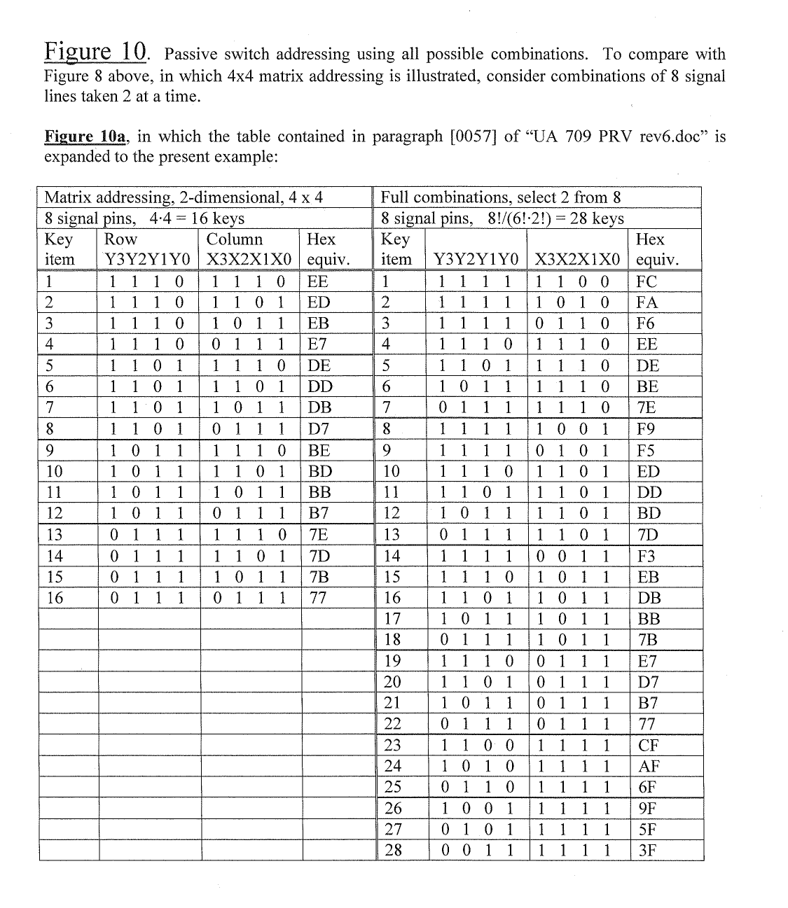

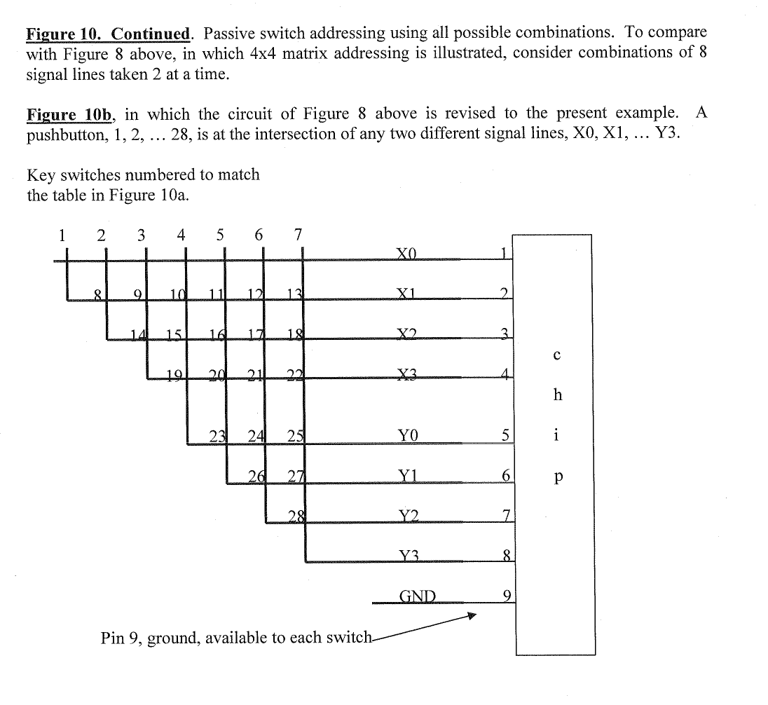

As a further alternative, in a similar manner, the shorting of sections of an antenna associated with the RFID tag can be accomplished by a short section of wire or other conductor. FIGS. 8A and 8B illustrate such an example. Two short wires 81 are fixed in electrical contact 82, each to a suitable portion of the antenna 83 of a tag 80. When the wire or other conductor sections are not connected, as in FIG. 8A, no short is created, and the tag can be read. When the wires are connected, as in FIG. 8B, a short is created, and the tag cannot be read. In this manner, the tag 80 is rendered operative or non-operative by enabling or disabling the antenna portion 83 associated therewith. It is further contemplated by this invention that another way to transmit controlling information to the equipment to be controlled is to periodically connect or disconnect these wires. Coming from some source such as a rotating cam on a machine, this can provide critical time dependent, and thus speed dependent, feedback to a control, and it is both wireless and very low power, or completely battery free.

In accordance with another embodiment, a method to enable the use of RFID technology to remotely control equipment is implemented by making modifications to the chip in the tag. One or more pins on the chip are provided to permit information generated by manually operated switches, or generated by a control instrument, to modify a portion or all of the stored information in the tag. As a result, a next read may contain a modified code that may be interpreted by the reader to generate a new request to the controlled equipment. Each tag may be assigned a range of identification numbers in which some bits may be fixed and one or more bits may be controlled by external switches through the external terminals, for example. Alternatively, each unique ID of a tag may simply have a few variable code bits appended to it.

Regardless of details of how code bits are included with the ID bits, the 0 or 1 state of each of the control code bits may be controlled by the external switches or other suitable arrangement, to provide a plurality of control codes. For example, with 5 bits designated as control code bits, 2⁵=32 different control codes are available. In general, with N bits available to the control code, the number of control codes follows the well-known exponential relationship:

number of control codes=2^{N}

As is described with reference to another example, six (6) external pins on a tag's chip are used to enable a five (5) bit code. By extension, an implementation calling for a sixteen (16) bit code environment (permitting 65,536 different control codes) may use seventeen (17) external pins. While such parallel data transfer is a possible approach, various methods to transmit data serially between components on a common circuit board are well known and may require only a few signal lines.

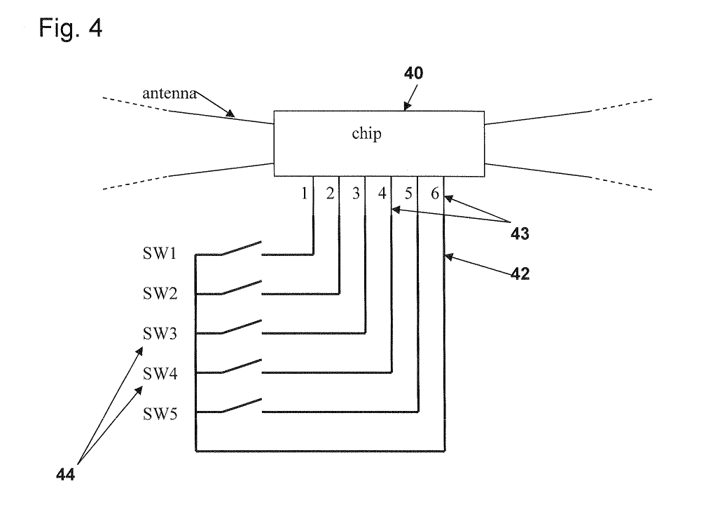

In accordance with additional embodiments, external signal input pins are provided to the IC (integrated circuit) of the tag. Switches that are properly attached to the pins may provide user adjustable binary information to the chip. As a result, the chip can transmit back to the RFID reader, binary information that is changeable according to the user's switch settings. FIG. 4 focuses on an example of a chip 40 of an RFID tag and shows six terminals 43 available for external connection. As a further example of such an implementation, one pin (in this example pin 6 carries the reference ground 42) may be internally tied to the reference node in the chip's circuit. The remaining five pins may be high impedance inputs, and be internally provided with individual weak (large resistance) pull-up resistors that return to the internal supply voltage node. These five pins are, therefore, available to indicate either a “low” voltage, or a “high” voltage, for example by connecting switches as shown. This example provides five switch-controlled binary inputs 44 providing a possible of 32 different combinations. Depending upon the application, the chip may contain some decoding circuitry. For example, if it is expected that only one of the switches in this example is to be closed at any one time, such a situation may be internally encoded into only three binary bits using standard methods of digital electronics. Alternatively, control codes may be selected by interfacing electrical signals other than switches to the chip pins.

In accordance with certain embodiments, a many-switch keypad controller is provided. The concept of a battery-less, wireless keypad controller has potential for a keypad containing only a few switches or actuators such as pushbuttons or the like. This may be expanded out to an application with many switches, such as are found on some modern television remotes or on a PC (personal computer) keyboard for example. Though this may be performed using a plurality of pins on the chip of the tag, it is also possible to implement such an arrangement by the use of a battery to drive the typical keypad/keyboard interface circuit. This circuitry could provide such functions as key scan, debounce, and encoding. A few pins may then be used to transfer those coded results to an (active) RFID tag to make the wireless connections to the TV or computer.

To make the keypad/keyboard completely wireless and battery-less, a more passive keyboard circuit may be used. Key switches could be encoded by passive connections, as opposed to an active circuit. This may be achieved with a matrix addressing circuit for example. In a matrix circuit, each key, when pressed connects three or four or more terminals together, one of which is a reference node (e.g., electrical ground). By providing three contacts under each switch, two-dimensional matrix addressing is provided. By providing four contacts, three-dimensional matrix addressing is provided. Higher order matrix connections are possible as well, in accordance with various embodiments. When such low-power, or wireless and battery free type keyboard circuits are desired, functions such as switch decoding and debouncing could be preformed in the reader and interface portion of the system, where electrical power is already available.

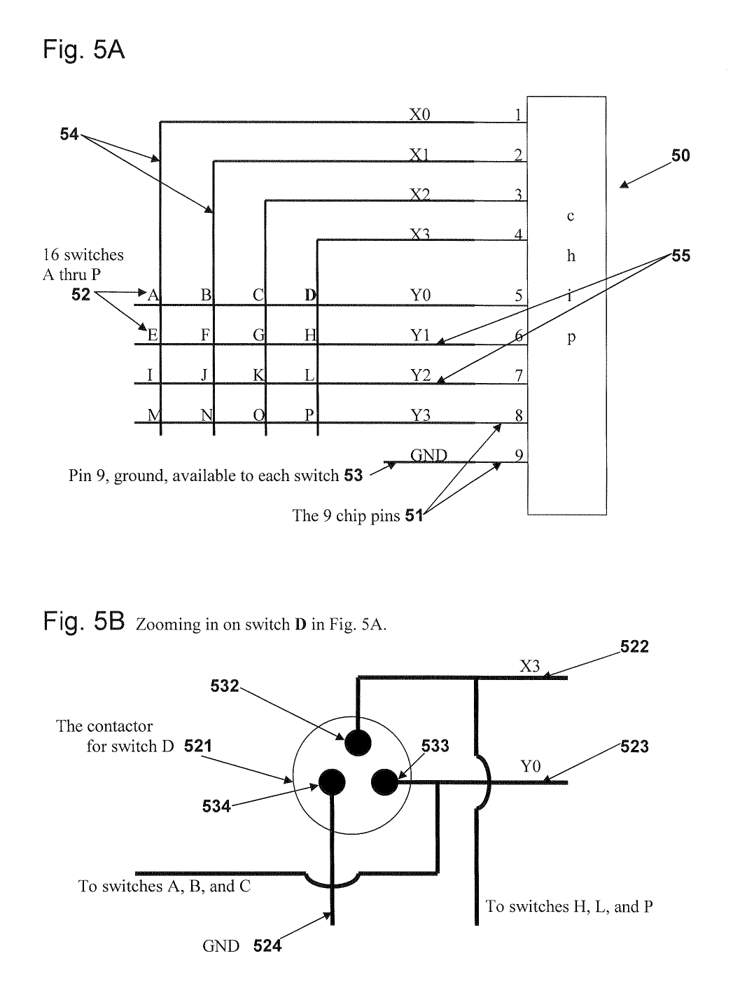

For example, see FIGS. 5A and 5B. The chip 50 of the tag may include a two-dimensional matrix addressing scheme that organizes the elements (e.g., switches) in rows and columns. In this example, sixteen (16) switches A through P 52 may be addressed. Each switch is addressed by one column signal line 54 (X0, X1, X2, or X3) and one row signal line 55 (Y0, Y1, Y2, or Y3). For example, switch G is at column X2 and row Y1. Each of eight (8) signal lines 54 and 55 (X0, X1, X2, X3, Y0, . . . Y3) connect to an input pin on the chip. With reference to FIGS. 5A and 5B, this is not attempting to show an actual circuit board layout, but is a conceptual depiction of a circuit. All column signal lines are insulated from all row signal lines, and from the ground node 53 that is available to each key. For example, switch G has directly under it a contact point for X2, Y1 and for ground. When switch G is pressed, X2 and Y1 alone are connected to ground, bringing only pins X2 and Y1 low, providing a unique pattern at the chip inputs. For further details regarding this example, see the section “ADDITIONAL DETAILS”.

The four row pins, four column pins, and one ground pin nine pins total, 51, allow sixteen (16) switches in this example. In general, the optimum area is a square such that, with N rows and N columns,

number of keys=N²,

number of chip pins=2N +1.

This may be acceptable for sixteen (16) switches, however, pin count gets into the twenties for 100 or so keys.

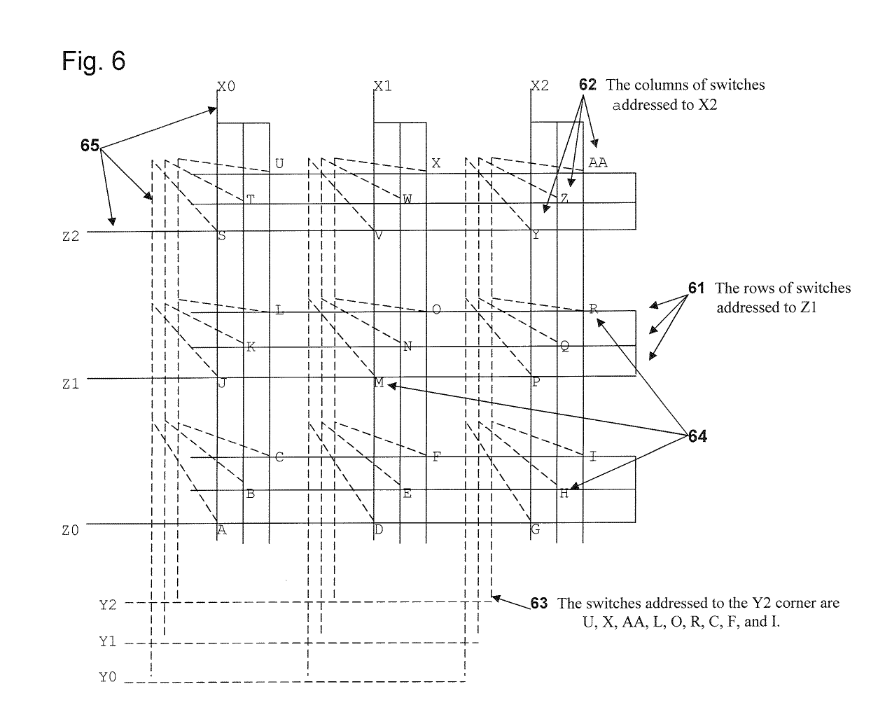

The three-dimensional matrix keeps pin count modest for 125 keys or more. In FIG. 6, an example of a three-dimensional matrix system for 3×3×3 keys labeled A through Z and AA, 64, each key has a unique address among the three dimensions X, Y, and Z. For simplicity in FIG. 6, the integrated circuit is not shown, though it would be connected to this circuit through pins in a fashion similar to what is shown in FIG. 5A. On the circuit board, under each key are four contacts including a ground contact one of the three X contacts, one of the three Y contacts, and one of the three Z contacts, similar to FIG. 5B. When a key is pressed, the circuit results in one of X0, X1, or X2, and one of Y0, Y1, or Y2, and one of Z0, Z1, or Z2 being taken low, uniquely identifying the key. Similarly to the two-dimensional matrix, in general the optimum volume is a cube such that an N×N×N cube may address:

number of keys=N³,

number of chip pins=3N+1.

Therefore, with N=5, 125 keys may be addressed which is more than enough for a full keyboard, using only sixteen (16) pins, wireless and no batteries.

It should be recognized that the matrix addressing scheme described above is only one pattern that may be used to assist in thinking about and designing a wireless very low power keyboard. To generalize from this matrix addressing scheme, the circuit may be based on each key pad bringing a unique selection of k signal lines in contact with the common node when that key is pressed. This amounts to selecting k signal lines from the total number of signal lines, call that t signal lines, available to the keyboard circuit. Each of the t signal lines is uniquely connected to an input pin. So in general, when t signal lines plus the 1 common node are available and a unique combination of k of those signal lines are terminated at the contacts under each switch, then the number of key switches that can be supported can be found from combination counting:

number of keys=C(t,k)=t!/(k!(t−k)!)

Looking at this addressing scheme this way, the two-dimensional matrix scheme of FIG. 5A described above had 8 total signal lines, in addition to the common node, and selecting combinations of any 2 of those signal lines, the maximum number of keys that could be supported would be:

C(8,2)=8!/(2!·6!)=40,320/(2·720)=28

The theory of this matrix and combination addressing is more fully developed in the section “ADDITIONAL DETAILS”.

With the novel change in the typical PC keyboard type of circuit that is an example of this invention, it can be used to make the keyboard wireless, and require less battery power or no battery at all. The circuit typically utilized for a PC keyboard, wireless or not, includes a two-dimensional row and column matrix of signal lines with each key facilitating a switch at each row-column intersection. Active circuits then scan these signal lines to detect specific key presses. Using circuits and addressing schemes similar to those described herein, the need for scanning circuits is eliminated and with radio frequency interface being accomplished with RFID type technology, the need for battery power is greatly diminished or eliminated altogether.

An additional advantage that may be obtained using this wireless keyboard method is that each transmission from the keyboard automatically comes with a unique identification, the tag's ID. This can assist the host PC to distinguish wireless signals originating in the specific keyboard from the wide variety of wireless signals originating in other sources commonly found in many a modern environment.

In implementing a wireless keyboard such as described herein, the reader may be embedded in the controlled equipment (e.g., a television or a personal computer) and the decoding, switch debouncing and other functions, often performed in the keyboard circuitry, are performed in the reader and its interface circuitry, in accordance with an embodiment. A fast tag and reader may help to accommodate fast key strokes and decipher near simultaneous key presses. Various switch encoding techniques or approaches may be used as may be desired for various particular applications.

In accordance with various embodiments, the reader portion of the controlled equipment is configured to respond in a particular manner to received identifications and/or control codes. The reader may be an embedded reader that is directly built into the equipment to be controlled, monitored or the like, with tags also possibly being embedded in the equipment to be controlled. Alternatively, for various applications, it may be possible that the reader and/or one or more tags are not embedded. In either event, the reader may compare the identification portion of the received signal to a stored list of virtually connected tags, rejecting those not connected. The reader then may properly interpret the control portion of the received signal, implementing the corresponding control action. For example, a first valid ID of a tag may turn a lamp (e.g., the load in FIG. 1) “on” and the only other valid ID of the tag turns the lamp “off”. Alternatively, simply changing from one valid ID to an other valid ID toggles the state of the lamp (e.g., from “on” to “off” or from “off” to “on”).

In some embodiments, the reader embedded with the controlled equipment may have, for example, a non-volatile memory to retain the list of tags to which the controlled equipment should respond. This list represents the tags that are virtually connected. The tag to reader virtual interface may be connected or disconnected in any suitable way, and various embodiments are described for reference. For example, a “connect” actuator may be provided on the equipment to be controlled, along with a “disconnect”, or a “clear” actuator. These functions would likely be utilized only at times of installation, remodeling, repair or similar infrequent operations. Such a “connect” action may be to bring the switch to be connected into the read range of the reader. In this way, pressing the “connect” pushbutton and, while pressed, activating the switch, this virtual connection may be accomplished. Selective “disconnect” may follow a similar procedure while a “clear” may delete all identifications from the stored list in the reader portion of the equipment. Such a tag to reader interface may be hard wired at the time of manufacture, or may be established in the field or in any other suitable manner.

In some RFID implementations, a tag, whether active or passive, may transmit a preprogrammed identification code. In wireless operation of equipment, in accordance with embodiments of the present invention, using the concept of enabling or disabling one or more tags, the tag's transmitted identification data indicate both the control action to be taken and the status of the virtual connection. In wireless control of equipment using the concept of providing one or more control pins for external connection to the chip, the chip of the tag is used to transmit a binary control code along with its unique identification. This can still carry the status of the virtual connection using basic methods already described.

In an effort to enhance reliability and minimize energy consumption even in the equipment being controlled, multiple strategies are possible. When a significant amount of time passes without any new signal identity or control request coming back to the transceiver, the transceiver can be made to transmit inquiring radio signals at much lower rate. Also, in such times of less activity, transmissions may be of lower power. To compensate for lowering transmission rates or power, any new receptions can be validated by a brief burst of higher than normal transmit rates or powers to verify a new request(s).

This invention describes ways in which RFID technology can facilitate wireless control of electrical equipment. In some embodiments the control point may comprise of one or a plurality of individual electrical signals each mechanically controlled by the process of opening or closing a switch. The mechanical operation of the switch may be initiated by machine or by human action. In other embodiments, the control point may consist of one or a plurality of other signals, such as photoelectric, photovoltaic, relay generated, or originating from any suitable source. Throughout the body of this disclosure, the words “switch,” “pushbutton,” “key”, or “key-switch” may be used with the intention to emphasize various exemplary implementations, however, those words are, in the final analysis, interchangeable.

As described in this invention, the electrical equipment being controlled will be accompanied by an RFID-type transceiver, or reader, and suitable circuitry to provide the interface between reader and equipment under control. Although terms like “reader”, “transceiver”, “interface circuitry”, “interface”, and “equipment to be controlled” may be used in this document in various ways to emphasize various of these functions, those skilled in the art will notice that any part of these actual circuit functions may be embedded more or less deeply and may be carried out in one or another actual circuit component. Therefore these terms are intended to refer generally to functional concepts, and not necessarily to specific circuit components.

Though most of this paragraph contains information that is familiar to those skilled in the art, it is included here to clarify foundations for methods to be described. When there are many switches serving as inputs, it is necessary to electronically distinguish which switch has been operated. Some methods are used in descriptions in this disclosure, but other methods could be used as well. The methods used herein start with the IC providing signal pins for external connection to the IC's internal circuit. These pins carrying electrical signals are high impedance inputs, each provided with individual internal pull-up resistors. As an alternate example, these pins could provide access to resistor and/or capacitor based circuits internal to the IC, for purposes such as modifying timing characteristics. Then, when a switch closes a circuit between a signal pin and the ground pin, the voltage on that signal pin is forced to be near ground voltage. This will be designated binary 0 at that signal pin. When no circuit is closed between any one signal pin and the ground pin, the voltage on that pin is allowed to be pulled up to nearly the internal supply voltage, or generally left open. This will be designated binary 1 at that signal pin. If the input switches are connected in a circuit such that two or more switches each can provide a closed circuit for one signal pin to be 0, then when any of those switches are closed, the signal pin will be 0, and only when all of those switches are open, will the pin be at binary 1. In summary, open circuit, or high voltage level at or close to internal supply is taken to be binary 1, and that will be taken to be logic true. Low voltage level at or close to ground is taken to be binary 0, and that will be taken to be logic false. Such an approach may allow generation of data over a backscatter RF signal by shorting out the antenna in an on/off type of serial data generation. Further, those skilled in this art will immediately realize that any other common assumption about “high” and “low” voltage range, or about what is taken to be 0 or 1, true or false can be made, and the results will be fundamentally unaltered. The scope of this invention is not limited to any one set of these assumptions.

A standard way to assign addresses to elements such as memory locations or switches on a keyboard in electronic systems is to assign them in binary counting order, or at least in some coded version of that. In such binary order addressing schemes, any number of the bits or signal lines will be taken to 0 by any addressed switch. This leads to complexities of circuit board design, and makes it impossible to distinguish a near-simultaneous pressing of multiple keys from pressing a third different key. To avoid these problems, the typical PC keyboard uses a well-known row and column scan approach. This requires active circuitry consuming a modest amount of electrical power. (For example, at this PC keyboard, a common keyboard distributed by a well known PC maker, I can generate the following sequence of characters by first pressing t, then additionally pressing h, then release t, then press t, then release h, then press h and so on keeping at least one of the letters pressed at all time, alternately releasing t or h, “thththt.” The keyboard accurately presents t or h instead of presenting a third key such as y.)

The method described here is to use a matrix or modified matrix addressing scheme wherein each key has the same number of zeros in its address; the same number of pins assigned to it. In general, the number of zeros is the selection number k, as used in the combination equation shown in paragraph [0043]. Thus in FIG. 6, key T has binary address Z2Z1Z0,Y2Y1Y0,X2X1X0=011,101,110, and key O has binary address 101,101,011. Since the specific selection of signal lines that is assigned to any key is unique, the binary pattern of zeros is also unique, but in all cases a fixed number, k, of zeros. When any two keys are pressed the binary address of the combination is the bitwise logical AND of the individual addresses, and must contain more than k zeros, assuming k is less than t, where t is the total number of signal lines. (In FIG. 6, k=3, t=3+3+3, and the number of addresses is 3×3×3.) Thus, for example FIG. 6, if keys T and O are both pressed, the binary “address” of this pair is 001,001,010, clearly not the address of any one key.

Whereas the binary “address” of a pair of keys pressed will always differ from the address of any one key being pressed, it is not necessarily the case that one pair is unique from any other pair. Thus, for example, in FIG. 6, if keys V and U are both pressed, the binary “address” of this pair is 011,010,100, the same as for the pair S and X. However, as long as the circuit is noticeably faster than the human hand, then in almost all cases, the decoding circuit in the host PC or other electronic equipment being controlled can detect the switch first pressed, and from that decode the one other key that was additionally pressed. For any embodiment needing to manage this and such additional elementary functions as detecting key release and switch bounce, the needed hardware or software can be placed out in the keyboard or placed in the host electronic equipment as best fits the power budget and overall design. In either case, the implementation of these functions is well known to persons skilled in the art.

A feature of this matrix addressing scheme is that each item addressed has the same number of zeros (or ones) in the binary address affording easy detection and decoding of the activation of two different addresses at overlapping times. A drawback of the matrix addressing scheme is that it is an inefficient use of available signal lines. Full selection of all possible addresses that are available while retaining the fixed number of zeros feature can be obtained utilizing combinatorial counting. And since the number of zeros in any address is still a fixed number, the ability to detect overlapping activation of two keys is retained. The following table illustrates the comparison between matrix and full combination addressing for a system in which 6 signal lines are available and we compare a 2-dimensional 3×3 matrix addressing with selecting all possible ways to select any 2 items from 6 total available.

| Matrix addressing, 2-D, 3 × 3 | | | | | | | | Full combinations, select 2 from 6 | | | | | | | |
|---|---|---|---|---|---|---|---|---|---|---|---|---|---|---|---|
| Key or | Row | | | Column | | | Octal | Key or | | | | | | | Octal |
| item | Y2 | Y1 | Y0 | X2 | X1 | X0 | equivalent | item | Y2 | Y1 | Y0 | X2 | X1 | X0 | equivalent |
| 1 | 1 | 1 | 0 | 1 | 1 | 0 | 66 | 1 | 1 | 1 | 1 | 1 | 0 | 0 | 74 |
| 2 | 1 | 1 | 0 | 1 | 0 | 1 | 65 | 2 | 1 | 1 | 1 | 0 | 1 | 0 | 72 |
| 3 | 1 | 1 | 0 | 0 | 1 | 1 | 63 | 3 | 1 | 1 | 0 | 1 | 1 | 0 | 66 |
| 4 | 1 | 0 | 1 | 1 | 1 | 0 | 56 | 4 | 1 | 0 | 1 | 1 | 1 | 0 | 56 |
| 5 | 1 | 0 | 1 | 1 | 0 | 1 | 55 | 5 | 0 | 1 | 1 | 1 | 1 | 0 | 36 |
| 6 | 1 | 0 | 1 | 0 | 1 | 1 | 53 | 6 | 1 | 1 | 1 | 0 | 0 | 1 | 71 |
| 7 | 0 | 1 | 1 | 1 | 1 | 0 | 36 | 7 | 1 | 1 | 0 | 1 | 0 | 1 | 65 |
| 8 | 0 | 1 | 1 | 1 | 0 | 1 | 35 | 8 | 1 | 0 | 1 | 1 | 0 | 1 | 55 |
| 9 | 0 | 1 | 1 | 0 | 1 | 1 | 33 | 9 | 0 | 1 | 1 | 1 | 0 | 1 | 35 |
| | | | | | | | | 10 | 1 | 1 | 0 | 0 | 1 | 1 | 63 |
| | | | | | | | | 11 | 1 | 0 | 1 | 0 | 1 | 1 | 53 |
| | | | | | | | | 12 | 0 | 1 | 1 | 0 | 1 | 1 | 33 |
| | | | | | | | | 13 | 1 | 0 | 0 | 1 | 1 | 1 | 47 |
| | | | | | | | | 14 | 0 | 1 | 0 | 1 | 1 | 1 | 27 |
| | | | | | | | | 15 | 0 | 0 | 1 | 1 | 1 | 1 | 17 |

The comparison of a 2 dimensional 3×3 matrix with selecting any 2 from 6 signal lines begins to show the comparison of efficiency, but as the sizes increase, the comparison rapidly becomes dramatic. The following table illustrates:

| Signal lines | Signal lines | Matrix | | | |
|---|---|---|---|---|---|
| available | at each key | Size | Count | Combination | Count |
| 6 | 2 | 3 × 3 | 9 | C(6, 2) | 15 |
| 8 | 3 | 2 × 2 × 2 | 8 | C(8, 3) | 16 |
| 9 | 3 | 3 × 3 × 3 | 27 | C(9, 3) | 84 |
| 10 | 2 | 5 × 5 | 25 | C(10, 2) | 45 |
| 11 | 3 | 3 × 4 × 4 | 48 | C(11, 3) | 165 |
| 12 | 3 | 4 × 4 × 4 | 64 | C(12, 3) | 220 |
| 15 | 3 | 5 × 5 × 5 | 125 | C(15, 3) | 455 |

It can be readily seen that the full combination choice is the more efficient in count usage. For example selecting 3 signal lines out of 11 available provides for even more keys than does the 5×5×5 matrix suggested earlier, and it uses 4 fewer signal lines. A wide variety of modifications of these examples is possible. Specific applications will likely inform the selection details.

In some cases, it is envisioned that a special switch input, perhaps a shift key, to the IC may have a special dedicated address such as a unique input pin. This way its function is always independent from all other inputs.

Signals on the pins are low frequency, low rise time, and thus can be made low current circuits so as to not place demands on the already tight power budget. Still, it is envisioned that early implementations of products from this invention may need some battery boost. Such battery requirements will, however, be much less than a wireless keyboard that must scan the keyboard, implement functions such as debounce and decoding/encoding, and generate most of the rf wireless signal.

This will describe FIG. 5B in specific detail and from that basis, make generalizations to other examples and embodiments. These basic methods are relatively well-known in the art, and are being mentioned here to clarify this addressing approach. Switch D in FIG. 5A is addressed by signal lines X3, 522 and Y0, 523. When D is pressed, it should connect X3 and Y0 to circuit ground, GND, 524. To do this, X3 and Y0, along with ground are connected to terminals, 532, 533, and 534 respectively. These terminals are physically supported in a suitable manner such as by a circuit board. An electrically conductive contactor, 521, is supported, for example by a spring, near but not in electrical contact with the terminals. The support is designed so that when switch-key D is pressed, it makes electrical contact among all three terminals, thus forcing X3 and Y0 to or near the ground voltage, and when switch-key D is released, X3 and Y0 are left open, at least as far as D is concerned. In any addressing scheme involving the selection of 2 signal lines for contact with ground any 2 signal lines as needed may be brought to terminals at each switch in a fashion such as this. Further, in addressing schemes where other numbers of signal lines must be selected for contact with ground the appropriate number of specific signal lines may be brought to an appropriate number of terminals for contact by each key-switch. Thus, key-switch K in FIG. 5A will have 3 terminals, for signal lines X2, Y2, and for GND, and key-switch P in FIG. 6 will have 4 terminals, for signal lines X2, Y0, Z1, and for the reference node, ground.

This invention discloses one very specific concept, that of placing radio frequency identification transceiver function with electrical equipment to be controlled, and placing RFID transponder function at the point of control input. This focus aims to maximize energy consuming function in the controlled electrical equipment, where power must in all cases be provided, and minimizes energy consuming function out at the point of control input. This one concept has many different embodiments, and each embodiment has a multiplicity of potential applications. A sampling of what this invention facilitates includes; wireless control using much less, or no battery power, and management of desired communications links by virtue of the RFID tag's built-in identification.

In one of the categories of embodiments, macro modifications to the RIFD transponder(s) are made by the controlling function. These modifications are typically received in the transceiver as a change in which tag(s) are read, and the transceiver, through its interface, can then bring about the desired control function based upon the ID read. Examples of macro modifications described are shielding or exposing some tag(s) from the radio frequency signal, partially shielding or exposing some tag(s), electrically modifying the antenna(s) of some tag(s), and simply turning active tag(s) on or off.

In the other category of embodiments, data modifications to the tag(s) are made by the controlling function. These modifications are received in the transceiver as a change in the data from the tags read, and the transceiver can then bring about the desired control function. Modified data can be modifications of some of the tag's ID bits or modifications of additional data appended to the binary ID. Signal modifications described are in the form of signals external to the tag's IC passing into it by way of pins on the IC. This allows external signals to modify binary bits that are transmitted as part of the tag's response to an interrogation. Various ways of providing these external signals are described, mostly through switches so as to provide a very low power circuit, or a circuit completely free of batteries. To facilitate very low power embodiments that include many switches, an addressing scheme is introduced that emphasizes each switch being connected to a set number, k, of the, t, available signal pins. Theory is presented indicating that the maximum number of switches that can be addressed is the count of unique combinations of k things taken from a set of t things. Since each key has a unique address, the simultaneous pressing of multiple keys can be appropriately detected.

To minimize energy consumed by the transceiver embedded in the controlled equipment, management of repetition rate and amplitude of the reader's interrogating signal is introduced. This can also be used to enhance reliability. The unique identity of each RFID tag easily facilitates the use of memory in the reader and interface function to manage virtual connectivity between control input and the equipment being controlled. The invention uses RFID technology or technology having the functionality of RFID technology to facilitate wireless remote control, with minimal to zero battery usage. The “wireless remote control” is a control action, initiated at the control point, using variations of RFID tag functionality, to cause a change in the control state of some equipment that is interfaced with the RFID reader. An intentional control action is acted upon the RFID tag or the like, with the specific intention to cause a change in the controlled state of the equipment under the control of the reader. Examples may be simply turning a ceiling light on or off, changing the speed of a fan, or changing the operation of electronic equipment such as a TV, stereo, DVD player, etc. The invention may allow such control with usage of low power, or even battery-free, operation at the switch/tag. The invention includes methods for utilizing other energy sources such as piezoelectric. The invention also provides for connecting the tag to reader using a unique method, and the switch/tag can have any number of switched states. The invention allows integrating large numbers of states selected by several switches to the tag's IC, and to cause the reader to change the state of equipment it might be connected to in some examples.

In various examples of the invention, a distinction is made between the point at which control parameter(s) are input or initiated, and the equipment under control. Regarding the “control point” and “equipment under control”, in many situations/environments it is desirable or even necessary for the control point to be separated some distance from the equipment being controlled. In such situations, the control point is connected to equipment using RF instead of wired connections. Implementation of this RF connection with RFID technology, placing the function of the transponder, “tag”, at control point, and the function of the transceiver, “reader”, at equipment. To diminish the need for power, especially battery power, at the control point, place power needy aspects of the control functions at the equipment under control. This provides advantages such as cross fertilization with existing RFID technology. A few of many examples of this may include resolving interference issues, especially in environments like hospitals or the like, between RFID used in item tracking and widely used electronic equipment. In another aspect, utilizing the ID of RFID for virtual connect/disconnect, and for passing control codes. Common applications of RFID raise security issues that are being solved, resulting in security solutions that can be implemented in remote control. The invention also allows environmental and cost savings due to less interconnecting wire, less batteries, and other interconnecting materials, and cost savings of less installation time, as interconnecting wire is not needed, as the hook-up is virtual not physical. Cost savings is also realized in easier remodeling activities. As described with reference to various examples, the invention may also be correlated or combined with existing, related technologies, such as for piezoelectric based remote control applications.

In general, in one aspect of the invention, the system and methods interface the RFID transceiver functionality, “reader”, at the electrical equipment to be controlled and place the RFID transponder functionality, “tag”, at the point of control input. Such a system can utilize many of the RFID technologies presently available, Gen1, Gen2, passive, active, semi-active, or those not yet available. There are a wide variety of applications, such as for example, residential wall switches, garage door openers, computer peripherals, remote controls, industrial applications. The invention includes methods of indicating/initiating control action at the point of control. Two different aspects are being addressed, the control action, and whether a certain control point is or is not virtually connected. As used throughout this application, words such as control action, switch, pushbutton, control signal, control input, all mean basically the same thing. One may be used to emphasize particular details, but this is not to limit the scope of the invention. The control action can be specified by macro modifications to the RFID tag. In these implementations, changes are made in which tag(s) are read by the reader function in the equipment, thus indicating that a change in control state is requested. Some examples of this include having a mechanism to shield a tag from or expose a tag to the radio frequency signal as described in above examples. In an alternative, with two tags, one may be shielded, one exposed, so as to have built in fault detection in that exactly one tag should be read each time. An example above is a representation of a two-tag system. A set of tags with a shield shaped so as to expose some subset of these, shielding the rest, mechanically or otherwise mounted, enables changing which subset is exposed as in examples above. In the tag shielding methods described and contemplated, the shielding may be total shielding of the tag surface area, or shielding only a portion of the tag's antenna can be used as well. This may be understood as a capacitive short-circuit of the antenna, or an actual short circuit may be provided. When shielding or exposing a tag or group of tags, partially or fully, the tag(s) and shield(s) move relative to each other. A variety of options in this regard are contemplated, such as having the tag(s) remain at fixed position and a controlling action moves the shield(s), the shield(s) remain at fixed position and a controlling action moves the tag(s), both tag(s) and shield(s) are moved differently by the controlling action, or combinations thereof. Short circuiting of the antenna can also be accomplished by attaching two wires, one near each of opposing ends of the antenna. When these wires are connected, that tag cannot be read, whereas when open, the tag can be read. Attaching wires to critical spots of the antenna, low frequency amplitude-shift-keying permits transmission of choices from a multitude of control requests. The systems and methods also may use active or semi-active tag(s), with a battery or batteries can be selectively connected or disconnected.

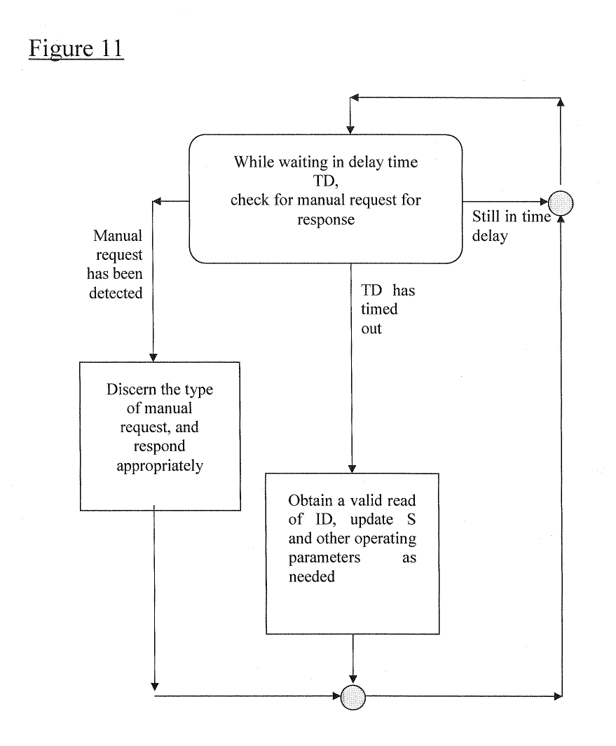

In the systems and methods, the control action may be specified by changing what is transmitted from any tag or tags, be it the ID, and/or a portion of the ID, and/or changing data appended to the ID. For example, through pins (or the like) on the tag's IC chip, there can be brought out circuit nodes that permit these changes. In exemplary implementations, the available pins comprise, a reference node, perhaps “ground”, and one or more high-impedance signal inputs each with a large value resistance returning to a different reference node, perhaps “supply”. For example, for parallel switch input; one SPST pushbutton (or switch) for each signal input pin may be used, with all pushbuttons returning to the ground pin as set forth in the example above. An addressed switch input, typically used where many switches/pushbuttons are needed, may be provided by implementing key scan circuitry at the point of control, perhaps using battery power if needed. To diminish or eliminate the need for a specific power source, implementing passive switch addressing may be provided. For example in a method, let the number of signal input pins available be equal to t. When also counting the “ground” pin, that makes t+1 pins total. Let the maximum number of pins that will be connected to “ground” at any one time be equal to k, where k<t. Each switch or pushbutton is designed to be normally open, with as many as k+1, contacts, one used to return to ground, the others connect individually to the switch's unique assignment of k (or in some cases, perhaps fewer) of the input pins. When a switch is pressed, its input pins are all connected to the “ground” node. FIG. 8B shows this for k=2. Some implementation examples are described as follows. A k-dimensional matrix pattern may be implemented. The t signal pins are subdivided into k groups, each containing t₁, t₂, . . . tₖ pins. For each switch, one pin of each group is selected for connection to one of each of its terminals, thus permitting t₁*t₂* . . . *tₖ uniquely addressed switches. Examples of this may include k=2, t=10, then 5*5=25 pushbuttons can be addressed, such as provided in FIG. 8; k=3, t=12, then 4*4*4=64 pushbuttons can be addressed, such as provided in FIG. 9. Of the t pins available, bring to each switch its own unique selection of k pins. The maximum number of pushbuttons that can be addressed using this scheme is determined from counting combinations. This count is t!/(k!*(t−k)!) . So that if k=3 and t=11, then 165 pushbuttons can be addressed, more than enough for a standard computer keyboard, such as shown in FIG. 10. If the number, k, of pins selected by each pushbutton is the same number at each pushbutton, but is a unique selection to each, then simultaneous pushbutton contact will result in more than k pins being momentarily grounded, and therefore can be detected. The pattern of pins grounded by a simultaneous switch press is the logical AND of the patterns associated with the individual pushbuttons. In various cases, it is possible to decode which switches were pressed together. In matrix addressing implementation, it is possible to decode which individual switches were pressed out of two switches being pressed together. There may also be special keys on a keyboard, or similar application, requiring such a special key to be used as a modifier that is pressed along with another key. Such an application may benefit from having a number of input pins assigned to that modifier key different from k. Although these examples make assumptions about the logic model used for this circuit description, those skilled in the art will recognize that other models, such as alternate logic level assignments, and circuit conditions, such as normally closed switches, will work as well. Further, although the examples describe the use of input pins, these pins could more generally be considered as signal pins and be used to develop other types of modifications. For example, capacitive modification of signal timing where at each signal pin, several switches can be distinguished by tying each switch in series with a capacitor returned to the ground pin. For example, four switches can be distinguished using capacitors in relative sizes of 1, 1.4, 2, and 4. This selection, or other similar non-linear selections, permits direct decoding of multiple switch presses. Resistive modification of signal timing can be done using methods very similar to as was described for capacitive modification of signal timing. Instead of focusing on timing, other signal properties can be modified such as amplitude or phase or some combination. Instead of focusing on switches as the source of control information, other sources of control information can be utilized. De-bouncing, switch decoding, and multiple switch press detecting and decoding can all be done at the equipment under control where electrical power supply is already present.

The status of the virtual connection between the point of control and the equipment being controlled is largely maintained by the reader function in the equipment, but tag(s) may also have impact on connectivity. For tag(s) to be connected yet transmit control function(s) some or all of their ID remains unchanged, that ID being stored in the reader-equipment. In cases where ID is changed, such as a multiple tag situation, all valid IDs are stored, perhaps along with the control functions to be implemented upon receiving that ID.

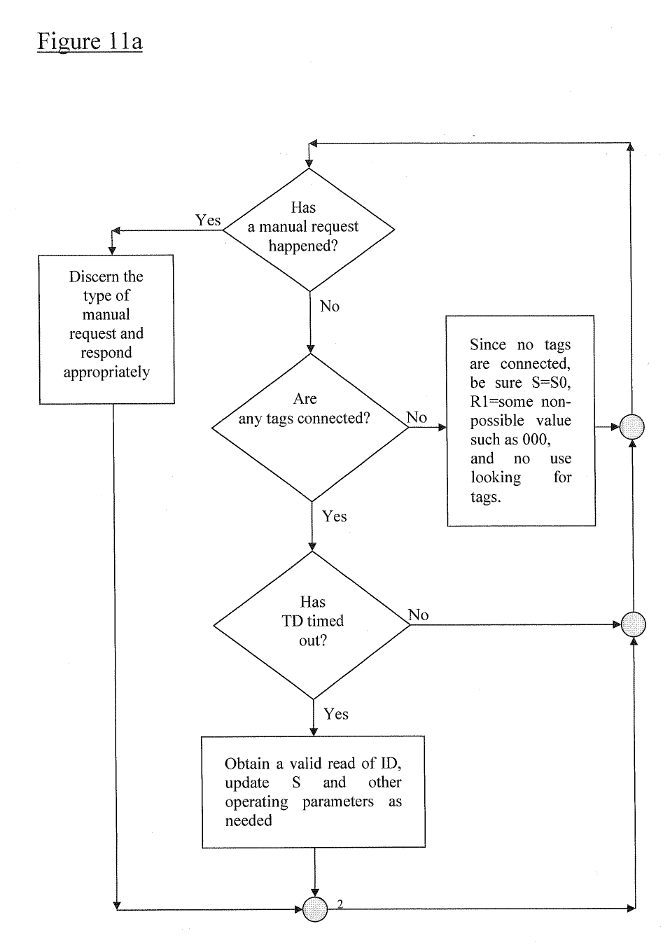

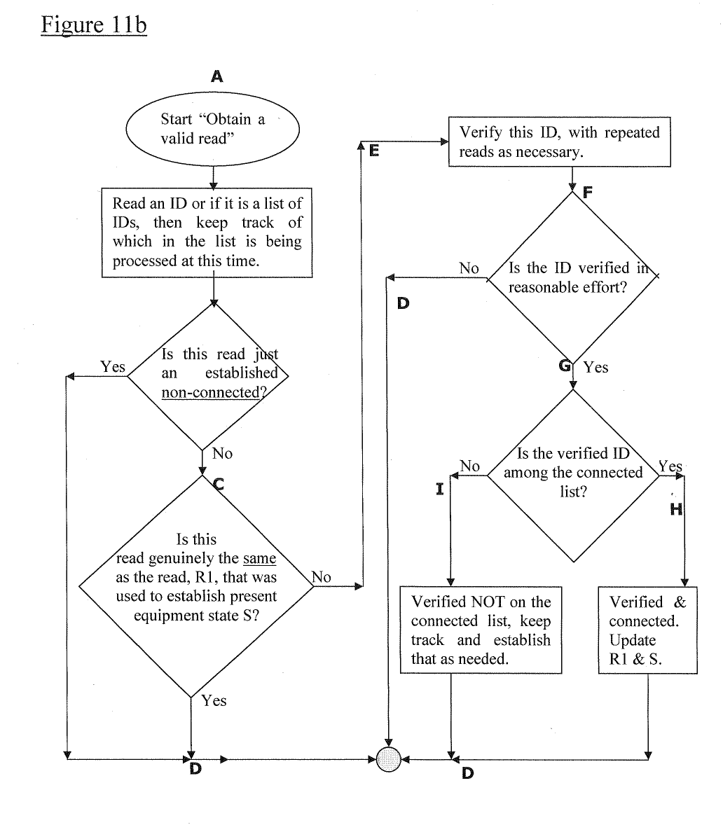

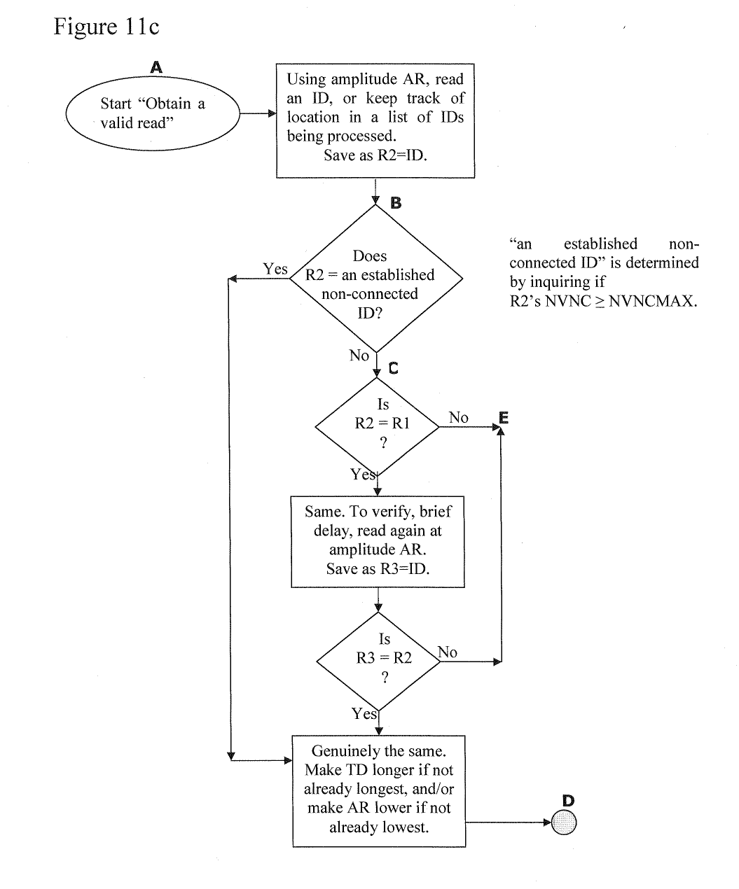

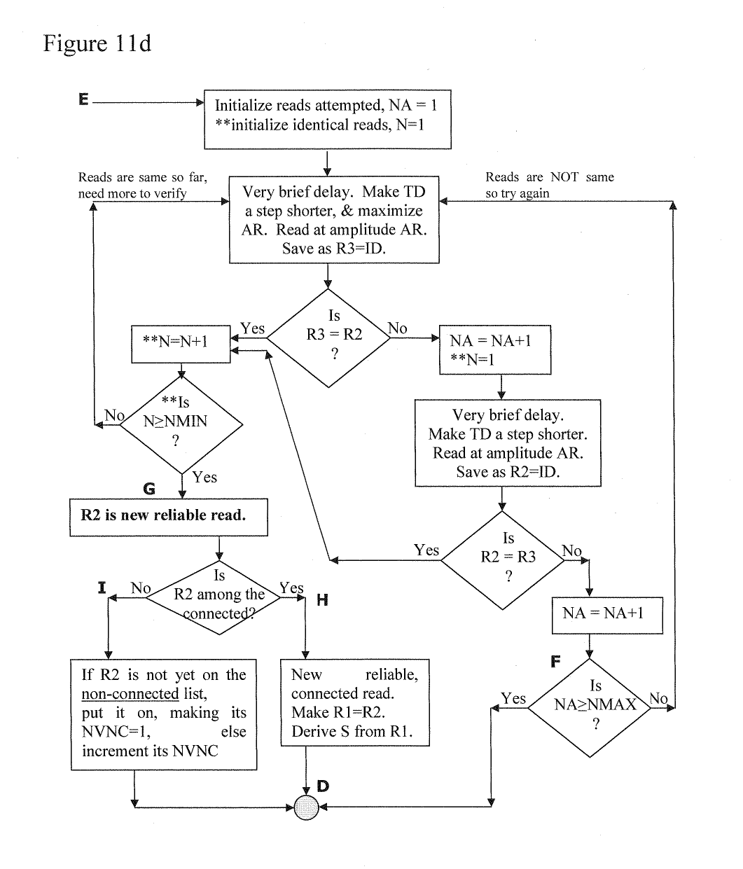

The invention also provides methods of carrying out control actions at the equipment under control. The RFID reader function and suitable interface may be part of, closely connected to, or fully integrated with the actual equipment being controlled. Any portion or the entirety of these functions may be programmed or installed anywhere along the manufacturing process, from the chip foundry, through production, and to installation and even by the end user. This reader and interface function may include aspects and capabilities, as appropriate to a specific application, comprising providing virtual connections, wherein to determine if any particular read is from a connected control point, methods may be included to identify the ID of a connected tag as well as methods to maintain and update this information. In an example, FIG. 11 shows a method flowchart relating to a software implementation according to the invention and features relating to examples. Basic hardware resources assumed may be a non-volatile memory that can retain the list of tag IDs that are connected. RFID reader function, including a) Output from this software to Reader to control; b) When a read is to be made and the amplitude of a RF pulse used to initiate that read; c) Inputs to this software from the Reader of the tag ID that has been read. In the event that the Reader deciphers more than one tag ID, the Reader may have the sophistication to sort that into one ID at a time being delivered to the host software. Manual inputs may be made, for example, to request one of a) A new tag ID is to be added to the list of attached tag IDs, b) to remove a specific tag from the attached list, c) to erase the whole list of attached tags, or other functions. In the method which may be implemented in software, the definition of some software quantities may include a) ID generalized to mean what has been read, from a tag read, presumably the tag's ID and other data that comes with that read if any, b) S=present state of equipment under control, c) S0=default initial condition used at first power up, and whenever no tags are connected to reader. Presumably this is a benign condition, such as off, d) R1=The ID that was used to obtain S. S is the decoded version of R1, containing only that code needed to drive the system under control, whereas R1 contains all the ID information arriving from the reader. If S=S0, the default initial condition, then R1=000, or some default value that cannot be read as ID, e) R2 and R3 are current and recently read ID, f) TD=delay time from one read to the next, g) AR=amplitude of the next automatic read, h) N=the number of identical reads in a row. ** i) NMIN=the minimum N required to call this a reliable read. Leave out flow chart blocks marked by **, and NMIN is assumed to be 2, j) NA=the number of attempts to find a reliable read, k) NAMAX=the maximum allowed number of attempts to find a reliable read, l) NVNC=the number of “verified non-connected” results for any one non-connected ID. A list of non-connected IDs is maintained along with NVNC for each, m) NVNCMAX=count of NVNC needed for the ID to be classified as “established non-connected”. FIG. 11 is a flow chart showing the control of the reader function. At this top level, an overall view of the whole function is shown. Subsequent FIGS. 11a-11e show more detailed depictions of each of these blocks. More specifically, FIG. 11a shows more detail of the block of FIG. 11 labeled “While waiting in delay time, TD, check for manual request for response”. FIG. 11b shows more detail regarding the block of FIG. 11 labeled “Obtain a valid read of ID, update S and other operating parameters as needed”. In FIG. 11b, the TD has timed out, the reader must read tag(s) in the environment, and discern which is(are) valid, connected tag(s), and make adjustments to TD, AR, R1 and S as necessary. In an example using a known reader chips, such as the Intel R1000 , and the Indy™ R2000 from Impinj, and in light of the assumptions made above regarding the Intel R1000 reader chip, the singular is assumed. In FIG. 11c, further detail of the block “Obtain a valid read of ID, update S and other operating parameters as needed”. The A, B, C, D, E sequence first shown on FIG. 11b is detailed. In FIG. 11d, the “Obtain a valid read of ID, update S and other operating parameters as needed” block is detailed and the E, F, G, H, I, D sequence of FIG. 11b is detailed. To arrive at E, either R2=R1 or R3=R2. This sequence needs to generate NMIN identical reads, if that read is a connected read, update R1 and S, the system under control. Adjust other parameters. FIG. 11e shows more detail of the block of FIG. 11 labeled “Discern the type of manual request and respond appropriately”. Some sort of a manual request has been detected. Manual request refers to the feature of user-operated pushbuttons or switches physically on or near the equipment under control that facilitate such functions as; add another tag ID to those connected for operating the equipment, delete one tag from the “connected” list, or clear out the tag list all together. The action needed in this section of software is to discern what is being requested, and to make it happen. It is anticipated that “tag validation” amounts to some action like sending a particular key code, or running the tag through an ON/OFF cycle, doing this action while the tag in within read range.

Memory such as non-volatile memory or look-up table contains information such as ID(s) of the “connected” tag(s) and perhaps interpretation of what action is to be implemented. To build and maintain this “connection” list some or all of the functions implemented may be a) A “connect” switch physically on the equipment under control could, while activated, permit any ID exposed/shielded, or modified, or containing changed data, to be added to the “connected list”; b) A “disconnect” switch could work in the same way as the “connect” switch; c) An “erase” switch could delete all IDs from the “connect list”. Possibly useful software concepts that relate to examples may include Field programmable; Maintain an address of; the start of the list, the end of available memory, the end of the list of occupied memory; Add a new ID to the memory list; Delete an ID from the memory list; Re-organize the list to get rid of hole left by the deletion; Clear all IDs from the memory. An assumption may be made that the memory for this purpose is contiguous.

To interpret control action and interface with equipment, it is possible to read the RFID tag, interpret the ID and the data received, and interface the requested control action to the equipment under control. For example the requested control action could be stored along with the connection IDs. There may also be power saving options in the “reader” function. In many applications, there may be long periods of time with no request for a change in the control state. The following features and benefits are possible to save power. Decrease the transmitted read power, duty cycle, or how often a read is transmitted. As soon as any signal is received suggesting a different control state is being requested, increase read power, duty cycle, or how often a read is transmitted. Maintain this higher level of interrogation until validity of read is adequately confirmed and requested control state again remains unchanged for an extended period of time. RF reflections off moving people provide another indication of pending change in control state, such as someone entering a room. This is another opportunity for the radar feature of RFID to help control the environment of a room.

According to further examples of the invention, there are piezoelectric and photoelectric (solar) powering of RFID tags may be provided for various applications. Applications of these technologies may include interaction with improvements anticipated in the electrical power grid, smart grid, and to basic asset management. Further, additional concepts utilizing surface acoustic wave RFID tags may be provided. Such embodiments may utilize reader chips such as the Intel R1000 or the Indy™ R2000 Reader Chip, a product of Impinj, or other suitable RFID reader chips or like technology. For providing energy sources for active or semi-active tags, the objective of minimizing battery use while obtaining significant advantages from having a source of power on board the remote control system is achieved using alternative sources to battery power. For example, piezoelectric and photovoltaic sources of electrical power are described in the following examples, along with their advantages and suggested methods of implementation. Using a piezoelectric source of energy to enable battery free or less-battery power in applications of active and semi-active RFID technology provides enhanced applications and methods. These energy source features may be used in conjunction with the various systems and methods of the invention, including, but not limited to, methods of initiating control action at the point of control, methods of addressing multiple switches, and methods, inclusive of software flow charts, of interfacing the reader functionality with equipment to be controlled. Utilizing these energy source features with RFID technology further leverages the cross fertilization of these applications with the engineering and technological developments that result from other RFID uses, such as asset tracking. For example, the unique ID on each tag facilitates managing multiple controls. Additional issues such as RF interference and security cross fertilize as well. Passive RFID tags that derive all their operating power from the interrogating radio frequency signal and thus need no batteries. Active tags obtain all their power from an onboard source such as a battery, and semi-active tags obtain some of their power from an onboard source, the balance from the interrogating radio signal. Active and semi-active tags, as the terms are used here, are intended with the broadest meaning, including tags with that broad functionality of utilizing an onboard power source(s) even if going by other names such as broadcasting tags, or battery-assisted tags or semi-passive tags, etc. Although many of the examples of the invention refer to using passive RFID tags to implement remote control of electronic devices, using active or semi-active types may be worthwhile for various applications. Using an alternative to battery power, the use of active or semi-active tags is possible using no or less battery power. As it may be desired to avoid the need for batteries in the remote control or remote switching unit, such alternatives make use of such tags possible while not sacrificing this objective. active or semi-active types may be used in any example if desired, and such use may be based on the assumption that their benefit was in the form of decreasing the need for battery, relative to non-RFID radio frequency remotes, because all RFID tag applications drive the need to be very power thrifty. Thus, remote controls that are based on RFID technology have cost, ease of use, and environmental advantages over other remote control technologies. These advantages stem from battery-free operation or from less battery operation i.e. smaller battery and or longer battery life. Other advantages to using the technology of active or semi-active RFID technology in wireless remote control are also provided. Although passive tags are less expensive and have greater lifetime than active or semi-active types and they can often sustain more harsh environments, active and semi-active tags have several advantages that may also apply well to remote control. Among these advantages are longer read range, they can be read in a wider variety of radio signal environments, and greater functionality is possible since the tag's circuitry does not need to rely completely on the meager power received from the interrogating radio signal. Additionally the reader does not need to broadcast full power radio bursts looking for tags in its vicinity, and in many cases this results in less radio frequency energy in the environment resulting in safety advantages and decrease in radio interference. A further advantage derives from the desire to keep costs of the reader functionality as low as possible. For example, tags that cost $2 to $3 more yet result in more modest demands on the reader function and result in decrease in its cost of $30 to $40 results in an obvious design benefit.

Batteries are typically assumed to be the source of onboard power for active and semi-active RFID tags. An alternative power source may be a photovoltaic source of on board power for active and semi-active tags being used in the applications of wireless remote control. For example handheld calculators powered through photovoltaic cells illuminated by just ambient room light are in common use. To further improve the applicability of photovoltaic power sources, on board energy storage can solve the problem of light as an intermittent source. As the technologies of rechargeable batteries and supercapacitors improve this becomes a more viable way to provide on board power to operate active or semi-active tags for use in remote control. While supercapacitors do not yet have quite the energy density of a good chemical battery, they possess many operational and environmental advantages over rechargeable batteries.

Another alternative may be the use of piezoelectric materials as the energy source for active or semi-active tags, to alleviate or lessen the need for battery power. Although piezoelectric power typically requires mechanical work on the piezoelectric crystal to stimulate any electrical energy from it, in the present invention, the control action is initiated through a mechanical action such as a switch, pushbutton, or cam. This is exactly the mechanical action needed to stimulate electrical energy from the piezoelectric crystal. Electrical energy can be generated from mechanical strain of the piezoelectric crystal. The physical switching action, acting upon a lever, knob, pushbutton or the like, can be coupled to piezoelectric material in such a way that the switching action strains the piezoelectric material, causing the piezoelectric material to produce a voltage difference and thereby power the active or semi-active RFID tag. The very action of that tag coming on and transmitting its signal to the reader function in the equipment under control can in some implementations be a sufficient event to initiate the control request. In other implementations, the switch action changes a feature of the tag such as has been described elsewhere in this document, and it can provide the energy for the tag to carry out the dialog with the reader. That dialog may be what is typical of an active RFID tag, or what is more typical of a semi-active tag, or new protocols or new classes of tags may be beneficial. A possible implementation is one in which the piezoelectric energized RFID tag initiates the radio signal to the reader. This way, the reader needs only to be in a listening mode until it detects a relevant signal. The following examples provide some further illustration.

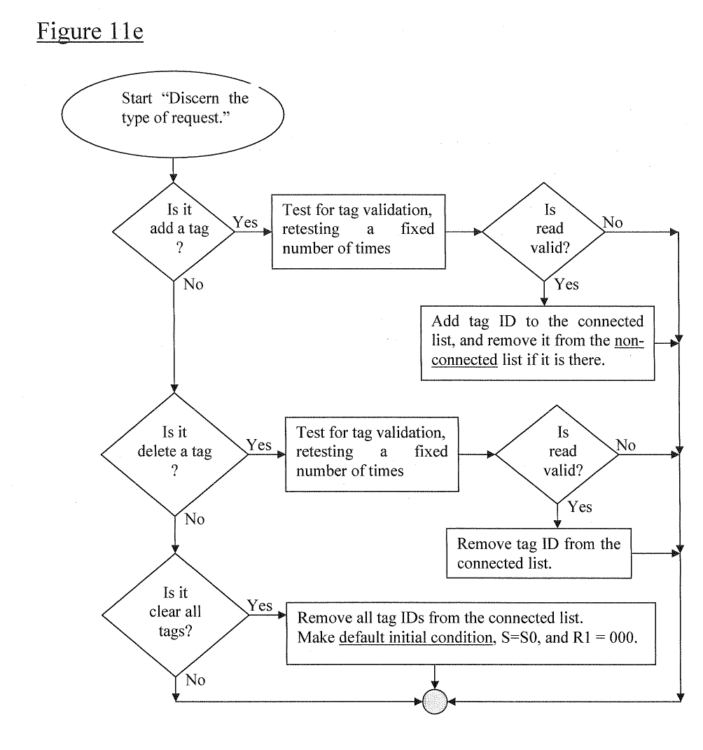

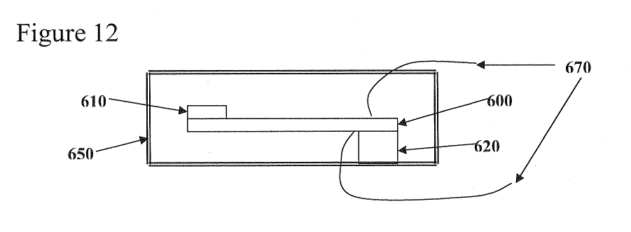

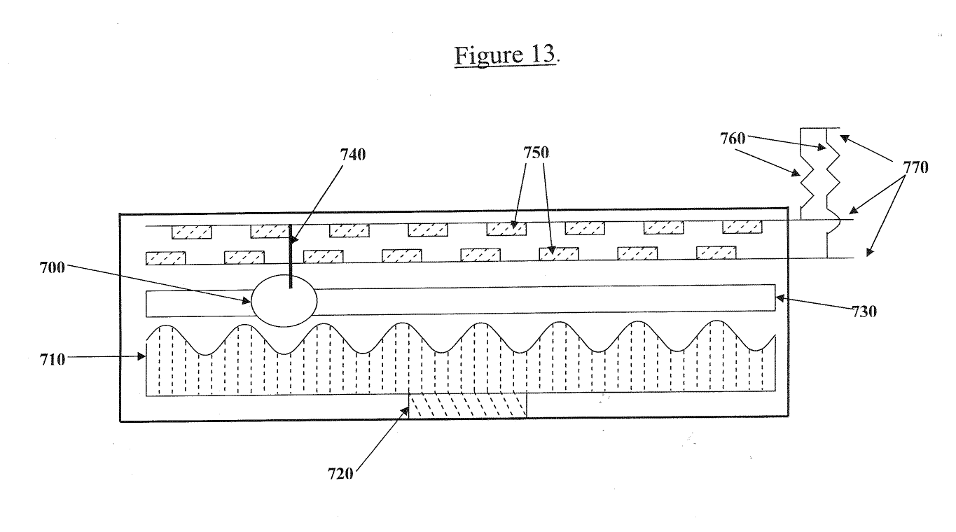

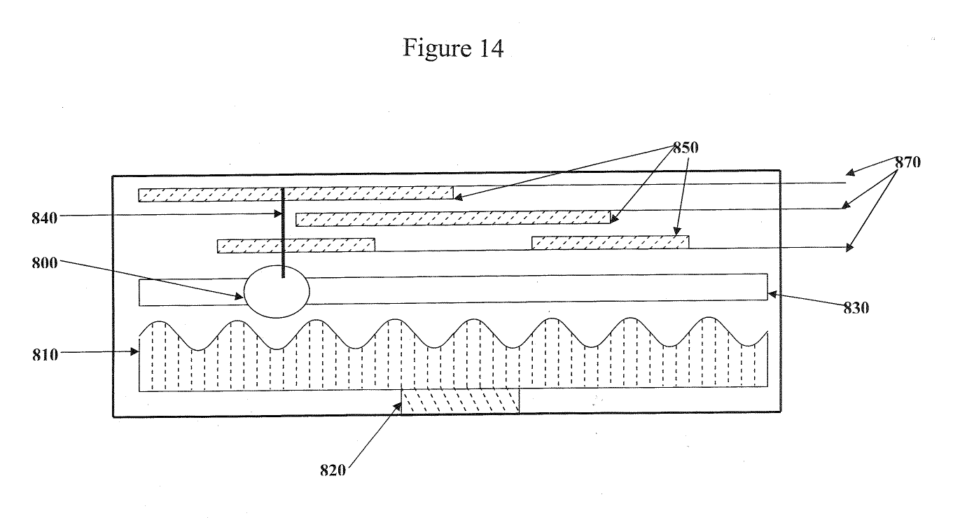

Some examples of implementation, obtaining useful electrical energy from a piezoelectric material. The piezoelectric energized RFID tag can initiate a radio signal when the piezoelectric crystal is subjected to strain caused by a switch lever. An example block diagram is in FIG. 12. In further examples, as seen in FIGS. 13 and 14, examples to cause the strain of a piezoelectric material to provide sufficient electrical energy to cause a battery-operated radio frequency remote control to carry out its control function without its batteries in place are also shown. A further application is for piezoelectric activation of RFID tags that have been designed under far more stringent considerations of battery life and with significantly more advanced technology. To obtain useful electrical energy from the switch-induced strain of a piezoelectric material in an efficient and cost-effective manner, a better circuit can be designed, such as using Schottky diodes in place of standard diodes to achieve lower forward-biased voltage drop. The use of voltage multiplying rectifier circuits, sometimes referred to as charge pumps, may be desired in some applications. For example these are used in some passive RFID tags to obtain sufficient voltage from the received radio frequency signal to supply the circuit. Optimizing the filter/storage capacitor (if it be needed at all) to meet characteristics such as deflection amplitude and deflection rate of the piezoelectric material, and to load characteristics. Optimizing the deflection amplitude, deflection rate, and the piezoelectric material itself to the needs of any particular application. Again, the supercapacitor may provide energy storage capabilities. For some applications, there may also be used a small rechargeable battery, or a supercapacitor to store the energy burst from the piezoelectric material over a longer term than may be possible with a capacitor. The systems could also include voltage regulation, such as a simple Zener, or perhaps a miniaturized 3-terminal regulator.

The other end of the interface between piezoelectric material and power supply for the RFID tag is at the piezoelectric material itself. The physical switch, pushbutton, or cam that initiates the control action may be mechanically coupled to a piezoelectric material so that by the action of that switch, pushbutton, or cam, the piezoelectric material is subjected to appropriate strain. Although each application may utilize a different configuration, one of ordinary skill will understand the basic approach. Some examples of implementation, utilizing this piezoelectric energy source to enhance the system are as follows. Relating to the “macro modifications” to a tag as was described earlier, reference was made to turning on or off the battery source driving an active or semi-active tag. Let that now include the switch initiated act of providing piezoelectric source of the power needed. This could be used in a single tag application or a multiple tag, multiple switch application. In applications involving the changing of what is transmitted, typically by utilizing one or several switches connected in one of several ways, parallel signal connections or addressed signal connections, there are several methods by which to obtain electrical power from the switch actions. A few are listed as follows for illustration. Those skilled in the art can develop specifics as needed. Signal switches are set to the proper condition, then a “send” switch has the piezoelectric material interfaced with it to provide the needed power for the tag to make or initiate the communication with the reader. Some or all of the switch actions are mechanically coupled to piezoelectric electrical energy sources. Many of these methods might be particularly suitable when the system also includes some mechanism to store electrical energy, using components such as capacitors, supercapacitors, or rechargeable batteries. Switch action implements the state request at the point of control AND strains a piezoelectric lever, arm or the like, to generate the electrical energy to cause the RFID tag to send out a radio signal. Each signal switch obtains its mechanical feel, action, or response in part or in whole from a piezoelectric material which in turn provides, or adds to, the power source. The signal connections of the signal switch are electrically separated from the mechanical-power generation of the switch. The signal circuits, involving the pushbutton's signal contacts, as discussed so far, are unchanged. The pushbutton's mechanical support has piezoelectric material and its electrical contacts added. Alternatively, an approach to more directly combine the signal action and the power generation action such that the addressing or signal circuits also carry power to the chip. The tag can typically remain in a low power state, such as the “sleep” state available on many microcontrollers, and wake up only when a change on signal inputs is detected. Upon waking up, it initiates dialog with the reader function. Reader and tag complete the necessary communication, and the tag goes back to sleep. Other solutions are possible, and the particular choice depends upon details of an application.

Some examples of implementation, obtaining useful electrical energy from photovoltaic supply, and utilizing this energy source to enhance the system. Methods of obtaining useful electrical energy from photovoltaic sources are based on issues of energy storage and voltage regulation. Some mention of these methods has already been made and those skilled in the art can readily make adjustments and additions as needed in a specific application. To utilize tags powered with a photovoltaic source many methods already described for passive tags as well as methods described for piezoelectric tags will work with minor adjustments. The key difference between photovoltaic on one hand, and passive and piezoelectric on the other is that the power source, or at least part of it, is already available, and not dependent on either the reader's radio signal or the mechanical actuation of a switch. Specific examples of using a photovoltaic powered active or semi-active tag are as follows. The previously described macro modifications can be used, especially using the acting switch(es) to connect or disconnect the power source to or from the tag(s). The previously described methods referred to as “changing what is transmitted” from the tag will work here. The tag can typically remain in a low power state, such as the “sleep” state available on many microcontrollers, and wake up only when a change on signal inputs is detected. Upon waking up, it initiates dialog with the reader function. Reader and tag complete the necessary communication, and tag goes back to sleep.

Using the wireless control system to enable interaction with the smart grid of the future. Once control of equipment is electronic, and especially wireless, it will be easier to interface with the smart grid. Smart grid refers to applying state of the art control methods to improve the electrical power distribution grid. Smart grid protocols are being developed by agencies such as Federal Energy Regulatory Commission (FERC), National Institute of Standards and Technology (NIST). With control of equipment based upon electronic methods, it will be more straightforward to install needed capabilities into the system. A few examples of the capabilities that may be beneficial follow. One of the major challenges to the power grid is when many loads such as air conditioners, or ceiling fans cycle on and off at the same time. This makes the grid is at one time over utilized, and then under utilized. So a solution is to permit the user to opt for an optional load to be on only when another load is off, or only when rates become lower, a sort of “auto save money” option that could then be reflected in a lower rate at the meter. Alternatively, when a user does request to turn on a load, the remote control could briefly flash a light emitting diode or make some other signal to indicate that now might not be the best time to bring it on. Request “ON” a second time immediately following the first request to override that suggestion and pay the higher rate anyway. Or pause a few seconds and then request “ON” the second time to implement “auto save money” turn on.

The use of piezoelectric powered tags in asset tracking applications may also be provided. There are item or asset tracking applications in which active or semi-active tags are very desirable. Yet it may often be useful to avoid the expense, financial, environmental or other, of using batteries. A possible solution exists in including an inertial-strained piezoelectric energy source for an active or semi-active tag. An example of implementing an inertial-strained piezoelectric energy source may include placing the piezoelectric material in a small tube. Fix one end of the piezoelectric material to one end of the tube, this also being the end to which its electrical wires are attached. Attach a small mass to the other end of the piezoelectric material. And, of course, this tube is attached to, and a part of the RFID tag. Then every time the tag is subjected to mechanical acceleration of almost any kind, bumped, moved from a rest, dropped or set down, the piezoelectric material generates an electrical signal. The qualifier “almost” is needed to recall that acceleration, linear or rotational, is a vector. So the orientation of the piezoelectric material may, in some applications, be important. One possible solution is to use multiple piezoelectric sensors, oriented in special, likely orthogonal, directions. This concept may be applied to RFID technology to provide various functionality. This opens a variety of possible applications for RFID-based item and asset management. Since a stationary item need not be tracked, presumably the data base knows where it is, and as long as it no longer hears from it, that is good. The reader will hear from it as soon as it is moved. Such a system could also measure shock and mechanical accelerations that an item is subjected to in transit. Piezoelectric microphones are common. This can be the basis for this application, and leads to the possibility of using these as environmental sensors even in battery powered RFID tags. These concepts can be generalized from specifically a piezoelectric material to any accelerometer as the source of the ability to locally measure acceleration, shock, bumps, spin.

Many applications of piezoelectricity, such as accelerometers or microphones, require accuracy, or at least linearity. Some of the applications envisioned in this invention do not require accuracy or linearity, only sensitivity, reliability and low cost. This would be the case in some applications developed below, such as detecting that a tagged item in stock is being moved, or theft prevention. Here, it is often best to simply detect that an item is being moved, such movement causes the tag to emit a radio beacon, the RFID reader receives that, and follows the tagged item using other already developed RFID and tracking methods. In cases where acceleration measurement need not be accurate, and perhaps it is only being used to cause the RFID tag to emit an initial radio beacon, physical mounting of the piezoelectric material can be modified with emphasis on sensitivity at appropriate levels and reliability. One way to enhance sensitivity is to provide a cantilever support for the piezoelectric material, and as needed, attach a modest mass to the free end, such as shown in FIG. 12. In FIG. 12, there is shown in cross section, is an example of a piezoelectric material being used to sense movement, specifically acceleration, of the tagged item. The piezoelectric material, 600, is mounted as a cantilever, optionally with mass, 610, on the free end to assist in designing the sensitivity to acceleration. To dampen unwanted vibrations, a foam adhesive, 620, to be used if needed, is suggested. Also shown is a protective container, 650. Possible electrical connectors, 670, near the fixed end are shown. This is only intended to be suggestive of one possible implementation.

Sensitivity can be controlled by appropriate adjustments in the length, cross section, and internal construction of the piezoelectric beam. It can also be controlled by appropriate adjustments of the mass at the end of the piezoelectric beam. Whenever a physical structure such as FIG. 12 is to be used, the issue of vibration induced resonance may be considered. It is completely possible that an item tagged by these methods can be sitting stationary on a shelf, and yet a motor elsewhere in the building is causing vibrations that however slight are in resonance with the piezoelectric beam and its mass. Such resonances must be damped. Fortunately once such issues are pointed out, methods for damping them are well understood. For example, the fixed end of the piezoelectric beam can be fastened to its support with an adhesive foam that absorbs mechanical energy. Another possible, and potentially less expensive, method to dampen unwanted physical oscillations in the piezoelectric accelerometer. The piezoelectric phenomenon is reversible. As considered so far, stress on a piezoelectric crystal causes an electric potential difference. The reverse can also happen. An electrical potential difference applied to a piezoelectric crystal causes mechanical deformation of the crystal. This reversibility implies that the electrical load to which the piezoelectric material is connected will have a feedback influence upon the material's bending, and thus upon its response to physical vibrations. So, electrical load can influence its resonance and dampening. By conservation of energy analysis alone, it is very likely that an electrical load that is primarily resistive and minimally reactive will provide dampening. The value of resistive load may be selected to pro desired performance, and would be particular to each specific application. Some of the possible examples of application for RFID tags that derive some or all of their electrical power from piezoelectric materials are listed as follows. Accelerometer-based inventory control: Using the piezoelectric material or other type of accelerometer, the tag, previously at rest, can respond to the tag being picked up, or otherwise respond to the tag entering a state of motion. This can be thought of as primarily sensing physical action upon the tag. Energy from the piezoelectric material or other type of accelerometer can be used to energize a tag that otherwise is off. The simple act of moving the item turns on the item's tag. The tag coming on can be sufficient signal to cause the reader to respond as designed, or the design can include added communication between reader and tag. Energy from the piezoelectric material or other type of accelerometer can be used to energize or signal to a tag that is otherwise fully powered, or in a semi-powered mode, such as a sleep mode. This simple act of moving the item's tag causes a new signal to activate an appropriate response from the tag. The tag can utilize the piezoelectric action to just generate new signal, and or provide some added electrical power to the tag's power source or storage. Possible specific applications include, inventory control, detecting if an item is being stolen, moved without authorization, detecting if a door is being opened, distinguishing that one, or a few items from among a large inventory of items, are being moved. In this last example, it frequently happens in an inventory asset management operation that there are many items in a small area, each with its own RFID tag. For a reader to attempt to read all such items at once is a challenging data interaction. It is much easier to simply listen for only those items that are being moved at any one time. In some cases it may be useful to use an accelerometer that measures the acceleration with some accuracy. This would be useful when there is benefit to monitor handling during shipment. For example integrate the mechanical work done on a tagged item over time. It also provides the information to integrate acceleration to determine velocity, and from integrating velocity, determine displacement. Knowing where an item was, and knowing its displacement, then one knows where it ends up. Numerical integration techniques utilizing modern integrated circuits are robust and inexpensive. Accelerometer-based wireless switch or remote control: For example, the remote control, such as for a television, is presumed usually to be hand held, and in motion when in use. Thus, accelerometer(s) in the control box provide power to the remote control. Such power source being intermittent, an electrical energy storage device such as capacitor or rechargeable battery would need to be included. Photocells could also provide added power for the system. Wireless switch or remote control deriving some electrical power or signal from the switch input action acting upon and deforming a piezoelectric material. This can be thought of as primarily sensing switch action. Much of this is fully developed in prior descriptions. A further example may be a digitized dimmer switch, or volume control. This control consists of a switch lever accessible to the user to be slid from one extreme to the other. It is digitized, as many such controls are, by sub-dividing the travel into a fixed number, N, of usually equal steps. As the lever is slid along its path it encounters bumps behind the switch plate. In this example of this invention, the lever is either mechanically connected to, or made of piezoelectric material from which operating power is derived, and or from which some of the signal information is derived. At each bump going in one direction, it causes a counter in the tag circuit to increment, and going in the other direction, it causes the counter to decrement. Direction can be determined by either sensing voltage polarity, or some other signal feature, from the piezoelectric material, or by phased contacts for signal wires. In FIG. 13, a digitized dimmer switch, or volume control, is shown from behind the switch plate. The sliding switch lever, 700, is accessible to the user at the front of the switch plate. The ridged item, 710, shown with ridges exaggerated, is attached to a piezoelectric material, 720, so as to cause varying strain on the material as the lever is moved along the slot, 730. Electrically the back side of the slider, 700, is returned to ground so that the contact, 740, that slides along with the slider connects the quadrature-positioned tabs, 750, to ground in an order that is dependent upon the direction of motion of the slider. The circuit interface consisting of two resistors, 760, and the terminals, 770, are suggestive of electronics typical of interfacing to the rest of the circuit, likely the IC of a RFID tag. Electrical connections to the piezoelectric material, 720, are not shown. FIG. 13 illustrates this example showing both the ridged item and quadrature phased contacts. This permits signal variations from the piezoelectric material to provide power and to indicate when another digitized step has been taken. Also shown is the possible inclusion of signals from phased contacts to verify step and direction. It is envisioned by this invention that in some applications, sufficient information can be derived from the piezoelectric signal that the phased contacts can be omitted.

In yet another embodiment of the same basic idea, instead of relying on a counter in the integrated circuit, use a fixed number, I, of signal lines to sense actual position along the travel of the slide path. With optimum design of the contacts available to those signal lines, the following well known binary equation holds: N=2^{I}

In the example shown in FIG. 14, binary gray encoding is used to enhance reliability of position detection. This figure shows a digitized dimmer switch, or volume control, shown from behind the switch plate, similar to FIG. 13, but using tabs that maintain the actual count of where the slider is. In similar concept are: The sliding switch lever, 800. The ridged item, 810, attached to a piezoelectric material, 820. The slot, 830. Electrically the back side of the slider, 800, is returned to ground so the contact, 840, that slides along with the slider connects the gray-code positioned tabs, 850, to ground so as to indicate the position of the slider. Making the assumption that an unconnected tab is binary 0, those skilled in the art will recognize that the slider moved to the extreme right of the figure is at position number 0 (gray code 000), the slider is shown at position number 6 (gray code 101), and the extreme left is position number 7 (gray code 100). A suggested interface circuit would use 3 resistors, not shown, one for each signal line 870, similar to what was shown for 2 signal lines in FIG. 13. In both FIG. 13, and FIG. 14, a rather small number, N=8, of steps is illustrated for simplicity. It would not be difficult to implement twice or four times as many steps, or in general as many digitized steps as needed.

In another aspect of the invention, switch-initiated alterations to a SAW tag are possible. A surface acoustic wave (SAW) tag is basically an RFID tag, but is unique in many ways. It is similar in that it has an antenna to interact with a radio frequency signal, for example 2.45 GHz, but it is different in that it does not need to generate DC power with which to operate the tag. Instead, the antenna is attached to an interdigital transducer (IDT), and the radio signal received by the antenna causes surface waves, also known as Raleigh waves, on the substrate. Additionally, the SAW tag includes a series of well positioned individual electrodes to act as reflectors. These reflectors reflect waves back to the IDT in a unique pattern representing the tag data. The IDT then converts the waves back into a radio frequency signal that is somewhat different from the received signal and when radiated back to the reader, carries the tag data. Switches can be arranged to modify the SAW tag and thereby modify the returned radio signal. This then would allow the reader function in the equipment under control to interpret the modified return signal and initiate control action in ways similar to what is described elsewhere in the patent. A few suggestions of methods to modify the SAW tag using switches, pushbuttons, cams or the like follow. The switch can bend the piezoelectric substrate slightly thus modifying the relative positions of the IDT and reflectors, and therefore modifying the reflected signal. Make macro modifications as suggested elsewhere in the examples of the invention, such as short circuit the antenna in any of several ways to “hide” the particular SAW tag from the reader. Switches can clamp onto one or more reflectors thus modifying their reflective properties and or the surface wave returned. Switches can interface with the IDT. There are some indications that SAW tags may soon be sufficiently inexpensive and small that one tag could be attached to one or just a few switches on any multi-key application. The switch(es) would then interface with the tag using one or a combination of the methods just mentioned. So the switch to SAW tag ratio can be optimized for any specific application.

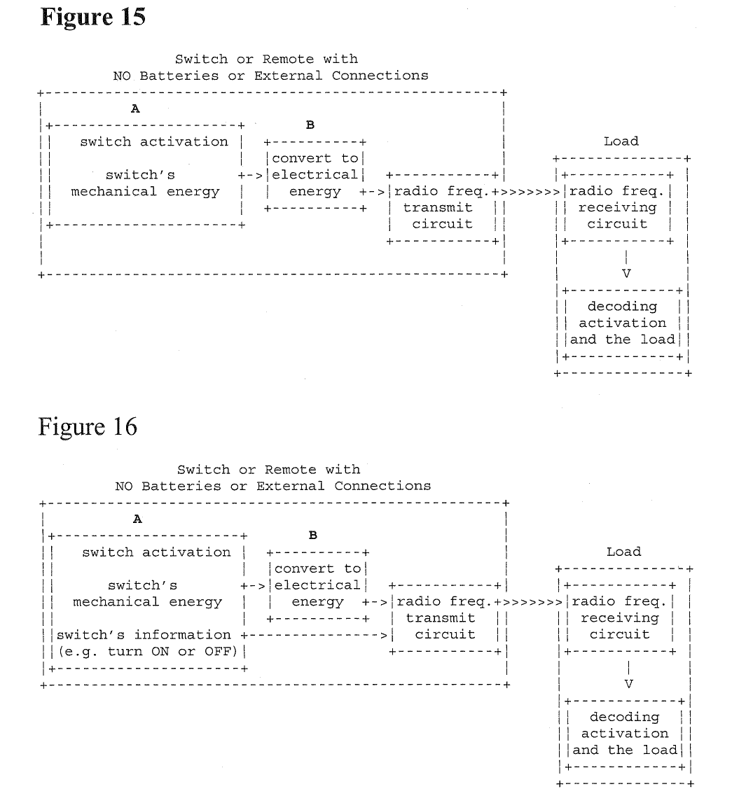

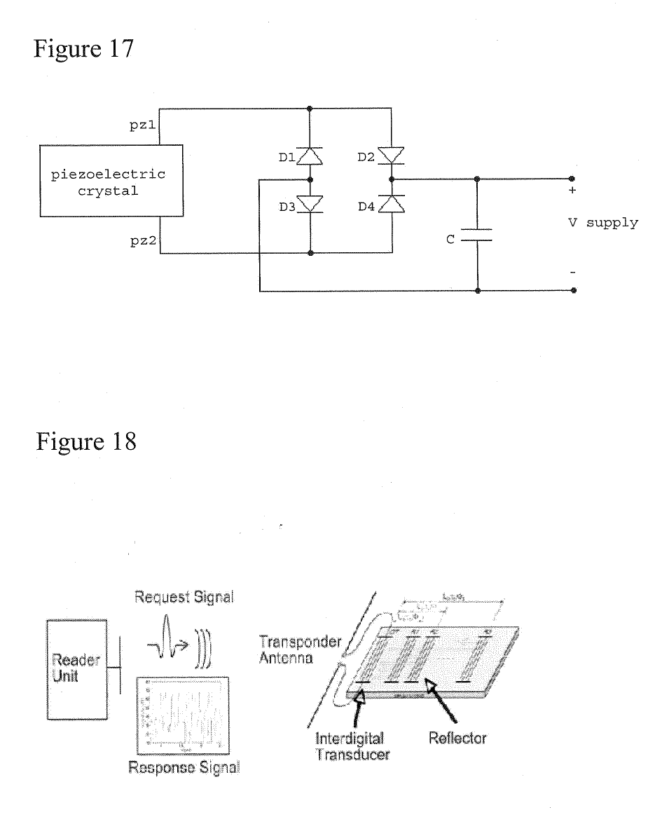

In FIG. 15, there is shown a schematic illustration of an example of the invention, with part A, the switch lever itself, and part B, the piezoelectric material in relation to a typical application. In FIG. 16, there is shown a schematic illustration of the invention, part A, the switch lever itself, and part B, the piezoelectric material in relation to a typical application. In FIG. 17, there is shown the circuit used to demonstrate an example where the piezoelectric crystal is subjected to suitable stress, which generates alternating electrical voltage at its terminals, pz1 and pz2 That voltage is rectified and temporarily stored in capacitor C to supply the voltage needed to energize the remote control.

In further example of the invention utilizing piezoelectric or other accelerometers to build a novel application to a traditional RFID application, asset tracking, and switch-initiated alterations to a SAW tag. Firstly, for use of piezoelectric powered tags in certain asset tracking applications. In passive operation it is envisioned that the accelerometer itself, upon significant movement, generates sufficient output power to at least cause the tag to transmit a signal that will initiate dialog with the reader. This might not be “passive operation” in the purest RFID tag sense, perhaps in some respects it is semi-active because the tag initiates the dialog. But it is passive in that the tag has no battery. In active operation, a combination is envisioned whereby the signal from the accelerometer (and this could be any of several accelerometer types, such as piezoelectric, capacitive, or piezoresistive) wakes up a tag that has gone into a very low power standby mode (in the jargon of many families of small electronic devices, sleep mode) and then the tag carries out appropriate dialog with the reader. The accelerometer in this case can be thought of as providing an additional battery saving function to the tag. There exists an almost continuous spectrum of possible variations on these two themes, as can be developed for any particular application.

For switch-initiated alterations to a SAW tag, current SAW RFID can support 10⁸ identifications, and may become an integral part of the consumer's product, not a throw-away tag affixed to an item of merchandise. In an example of a larger ID implementation such as a computer keyboard, using for example 125 keys, this provides about 800,000 totally distinct possible keyboards. The chance of unintended matches is quite small even if many more than this are made. The SAW tags also can be influenced by external actions upon the SAW RFID tag, such as on the returned signal. Temperature, torsion and pressure may deform the crystal slightly, thereby changing the shape of the acoustic wave as it travels across the reflectors. Thus, by analyzing the wave deformations, the interrogators can also determine a SAW tag's temperature and the shock or pressure to which it is being subjected. The SAW tag may thus be used both for identification and for sensing environmental factors.

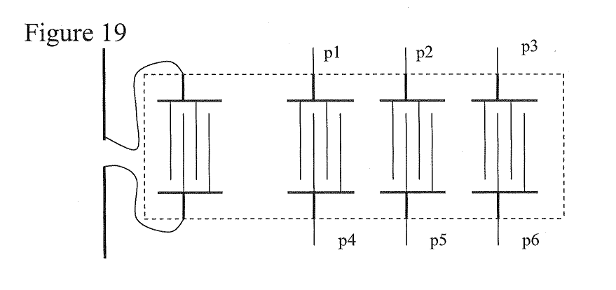

According to the invention, further suggestions regarding methods of implementation may include the following. Many of the “macro modifications” for silicon-based RFID would apply here; shielding, partial shielding, short-circuiting the antenna. Additional “macro modifications” are envisioned, such as switch action bending the SAW RFID tag. Much information is out there stating that this changes the returned signal in ways that are detectable. Switch action twisting the SAW RFID tag. This suggests use of a selector dial with perhaps a spring to provide the correct feel, using methods well known to those skilled in the art. Those skilled in the art can readily see that bending or twisting could be implemented by either a toggle switch, cam, rotary knob, or other suitable arrangement. In general, entities, such as switches, external to the SAW RFID tag can be made to interact with the tag in such a way that the returned signal is detectable as modified from what would otherwise be detected. It was mentioned an example with switches interacting with the SAW RFID tag. In FIG. 18, a diagram of a SAW RFID tag is shown. This figure suggests that the reflectors built into the tag are similar to the Interdigital Transducer attached to the antenna. Such an arrangement will permit modification to bring each end of each reflector out to an external pin. In FIG. 19, such a modification is illustrated. This modification will provide ways for external switches to be interfaced with such a tag. The external entities, for example switches being open or closed, will modify the reflective properties of the reflector, thus causing a change of the wave reflected back to the antenna's IDT, and causing a change in the radio signal the SAW RFID tag returns to the interrogator. Some examples of how this might be implemented follow. Connect entities, such as a switches, one to each pair of external pins, p1-p4, p2-p5, and so on. The switch ON/OFF state will significantly modify the reflected signal which the reader function can interpret to the equipment under control. Tie one node of each pair of external pins together and that common node can be thought of as the GROUND pin as discussed in the “UA 709, Technical Outline FOR Comparison with Claims.” For example, referring to FIG. 19, pins p4, p5, p6 together might be the GROUND, then the other pins, p1, p2, p3, and so on can be utilized for any variety of switch addressing. Again, switch conditions will modify the signal; returned. Other connections are possible, such as using one of the antenna pins as the GROUND pin, then all reflector pins, p1, p2 through p6 can be used for the switch addressing, greatly increasing the number of switches that can be addressed. The modification to the standard SAW RFID tag in which terminals, p1, p2, . . . p6, are brought out from the reflectors to provide for external switch connections. This is only intended to be suggestive of one possible implementation. More reflectors may be used, and thus additional pairs of pins are possible. in certain asset tracking and other applications.

The examples and methods described to make this happen are described along with procedures and some flow charts, methods ranging from macro modifications on passive tags to tags with switched inputs and piezoelectric sources of electrical energy at the tag, and include examples from wireless computer keyboards to semi-active tags with piezoelectric accelerometers to detect motion of the tagged item. A large variety of other applications are within the scope of the invention, and would occur to those skilled in the art, and are encompassed within the claimed invention.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method to wirelessly control an apparatus or device, said method comprising:
Providing the functionality of at least one RFID tag at the point of control and the functionality of an associated reader in conjunction with at least one electrical apparatus,
selectively causing at least a portion of the information on the at least one RFID tag to be read by the associated reader, and through proper interface, to produce a control command which is delivered to the at least one electrical apparatus to cause the intended action by or in the apparatus.

2. The method of claim 1, further comprising the method of:
using at least one shielding system to selectively isolate the at least one tag from, or expose it to the radio frequency interrogation signal from the associated reader.

3. The method of claim 2 wherein the method of exposing the at least one RFID tag to the interrogation signal causes the associated reader to read the presence of the tag, upon which at least one control action is executed.

4. The method of claim 2, wherein the method of isolating the at least one RFID tag causes the associated reader to read the absence of the tag, upon which at least one control action is executed.

5. The method of claim 2 wherein the method of exposing the at least one RFID tag to the interrogation signal causes the associated reader to read the presence of the tag, upon which at least one first control action is executed, and the step of isolating the at least one RFID tag causes the associated reader to read the absence of the tag, upon which at least one second control action is executed.

6. The method of claim 2, wherein the method of using a shielding system selectively isolates at least one and exposes at least one of a plurality of RFID tags out of a predetermined plurality of available RFID tags.

7. The method of claim 6, wherein the selective isolation and exposing of at least one RFID tag causes a predetermined control action initiated by the associated reader which is determined by the predetermined combination of the at least one RFID tag it reads, and modifying the at least one RFID tag that is isolated or exposed causes a different predetermined combination to be read to cause a different predetermined control action.

8. The method of claim 2, wherein the relative position of the at least one shielding system is changed by mechanical movement thereof.

9. The method of claim 8, wherein the mechanical movement of the at least one shielding system is caused by an actuator selected from the group consisting of a toggle switch, a rotary switch or combinations thereof.

10. The method of claim 1, further comprising providing at least one active RFID tag having a battery power supply, wherein the reading of the at least one active RFID tag is performed by selectively connecting or disconnecting the at least one active RFID tag from its associated battery source to selectively provide power to the at least one RFID tag where it then can be read by the associated reader.

11. The method of claim 1, further comprising the method of selectively covering or leaving exposed a portion of an antenna associated with the at least one RFID tag using a shielding material, whereby covering of the antenna portion causes the RFID tag to not be read by the associated reader, and leaving exposed that antenna portion causes the RFID tag to be read by the associated reader.

12. The method of claim 1, further comprising the method of selectively causing a short circuit in an antenna associated with the at least one RFID tag, whereby causing the short circuit causes the RFID tag to not be read by the associated reader, and opening the short circuit causes the RFID tag to be read by the associated reader.

13. The method of claim 1, further comprising the method of utilizing at least one signal connection to the at least one RFID tag's integrated circuit, this signal connection also being referred to as a pin on the chip, or as an input pin, and optionally, an additional pin makes an internal circuit common node, also known as “ground” available external to the chip, further optionally several or all input pins have internal high impedance pull up resistors, or they may provide access to internal circuits so as to permit controlled modifications such as timing changes, these optional features, and other versions of them, being well known to those skilled in the art.

14. The method of claim 13, with the further intention of facilitating modification of the tag's ID or modification of data that can be transponded by the tag.

15. The method of claim 14, wherein direct signal connection is achieved by connecting signal lines externally to the integrated circuit to at least one switch that is usable to implement a code onto the data the tag sends in response to the interrogation signal from the associated reader.

16. The method of claim 15 wherein several switches each have one terminal individually connected to one of several input pins, and the other terminals of each of the switches are together connected to one ground pin of the IC, in the parallel data transfer method well-known to those skilled in the art.

17. In further development of the method of claim 16, a number of switches greater than the number of available input pins can be implemented with proper addressing.

18. The method of claim 17, further comprising the method that each switch, or pushbutton, or key-switch, is the type that, when pressed, brings all of its electrical terminals into electrical contact with each other, and when released, leaves all of its terminals open.

19. The method of claim 18, further comprising the method of selecting a subset of the input pins for connection to each switch, this subset being unique to each switch.

20. The method of claim 19, further comprising the methods of:
a. connecting the ground pin to one of the terminals on each switch,
b. and connecting the subset of input pins as selected in accordance with claim 19 such that one input pin is connected individually to one of the switch's terminals,
c. and each switch shall have a sufficient number of terminals to accommodate the ground and input pins assigned to it.

21. The method of claim 20, further comprising the method, for most switches, of making the number of input pins selected in accordance with claim 19 a fixed count, which count shall be symbolized by k.

22. Using the method of claim 21, in which:
a. the total number of input pins being utilized for the purpose described here is t,
b. and the number of pins in the subset uniquely selected for each of these switches is k,
c. the number of switches that can be addressed can be found from counting these combinations as C(t,k)=t!/(k!(t−k)!).

23. The method of claim 21, further comprising the use of a matrix pattern addressing scheme, in which:
a. that fixed number, k, of input pins making up the subsets selected from those available, is the dimensionality of the matrix,
b. and all those t input pins available are then sub-divided into k groups, each individual signal pin in each group selects the address along that group's dimension of the matrix.

24. The number of switches that can be addressed using the method of claim 23, in which the sub-divided groups of input pins number t₁, t₂, . . . tₖ is given by the product of these group counts=t₁*t₂*tₖ, and though typically smaller than C(t,k) as spelled out in claim 22, may in some cases be easier to implement, or have other advantages such as indicated in claim 28.

25. The method of claim 21 can be utilized to assist with detection and decoding of simultaneous or overlapping key presses, since whenever two or more keys are both pressed, the pattern of signal pins taken low is the bitwise AND of the pattern of signal pins taken low for either key, thus bringing more than k signal lines low, and each individual key has a unique pattern of a known number, k, of signal lines taken low.

26. The method of claim 25, further comprising, the realization that with each switch possessing a unique pattern of k signal lines it can take low, then any overlap of switch pressing can be detected and not confused with just being another key.

27. The method of claim 21, further comprising, as long as it is possible to detect one key being pressed ahead of another, then it in some cases is possible to decode which key needed to be ANDed in order to make up the overlap pattern.

28. The method of claim 23, further comprising, as long as it is possible to detect one key being pressed ahead of another, then it is always possible to decode which key needed to be ANDed in order to make up the overlap pattern by looking at the difference between the overlap pattern and the first pattern.

29. The method of claim 14, further comprising connecting any of a multiplicity of control or data sources into the tag's IC and through that to the equipment under control, these data sources could be for example, a more typical keyboard.

30. The method of claim 1 offers opportunities to retain wireless connection between the point of control input and the equipment under control, while diminishing the electrical power needed at the control input, perhaps to the point where no battery is needed.

31. The method of claim 30 further comprising the placement of functions such as debouncing and decoding in either the point of control or the equipment being controlled.

32. The method of claim 1, further optionally comprising that the functionality of the associated reader, its interface and or the electrical apparatus under control include some or all of the following as is appropriate to any particular application;
a. non-volatile memory that contains, among other items, a list of the virtually connected points of control (tags),
b. factory-installed list of tag(s) that are or may possibly be virtually connected,
c. field-accessible points of access such as switches or buttons or contacts to enable appropriate additions to or deletions from the list,
d. one example implementation within the scope of this invention is to have a button on the reader labeled “connect” and the instructions to bring power to the reader and apparatus, bring the control selector into reader range, press the “connect” button while activating the control selector.
